(19) United States
(12) Patent Application Publication
(10) Pub. No.: US 2013/0113888 A1
(43) Pub. Date: May 9, 2013

(54) DEVICE, METHOD AND PROGRAM FOR DETERMINING OBSTACLE WITHIN IMAGING RANGE DURING IMAGING FOR STEREOSCOPIC DISPLAY

(71) Applicant: FUJIFILM CORPORATION, Tokyo (JP)

(72) Inventor: Takehiro KOGUCHI, Saitama-shi (JP)

(73) Assignee: FUJIFILM CORPORATION, Tokyo (JP)

(21) Appl. No.: 13/729,917

(22) Filed: Dec. 28, 2012

Related U.S. Application Data
(63) Continuation of application No. PCT/JP2011/003740, filed on Jun. 29, 2011.

(30) Foreign Application Priority Data
Jun. 30, 2010 (JP) 2010-150133
Feb. 9, 2011 (JP) 2011-025686

(51) Int. Cl. H04N 13/02

(52) U.S. Cl. CPC H04N 13/0203
USPC 348/46

(57) ABSTRACT

An obstacle determining unit obtains predetermined index values for each of subranges of each imaging range of each imaging unit, compares the index values of the subranges at mutually corresponding positions in the imaging ranges of the different imaging units, and if a difference between the index values in the imaging ranges of the different imaging units is large enough to satisfy a predetermined criterion, determines that the imaging range of at least one of the imaging units contains an obstacle that is close to the imaging optical system of the at least one of the imaging units.

### BACKGROUND OF THE INVENTION

1. Field of the Invention

The present invention relates to a technique for determining whether or not there is an obstacle in an imaging range of imaging means during imaging for capturing parallax images for stereoscopically displaying a subject.

2. Description of the Related Art

Stereoscopic cameras having two or more imaging means used to achieve imaging for stereoscopic display, which uses two or more parallax images obtained by capturing the same subject from different viewpoints, have been proposed.

With respect to such stereoscopic cameras, Japanese Unexamined Patent Publication No. 2010-114760 (hereinafter, Patent Document 1) pointed out a problem that, when stereoscopic display is performed using parallax images obtained from the individual imaging means of the stereoscopic camera, it is not easy to visually recognize such a situation that one of the imaging lenses is covered by a finger, since the portion covered by the finger of the parallax image captured through the imaging lens is compensated with a corresponding portion of the parallax image captured through the other of the imaging lenses that is not covered with the finger. Patent Document 1 also pointed out a problem that, in a case where one of the parallax images obtained from the individual imaging means of the stereoscopic camera is displayed as a live-view image on a display monitor of the stereoscopic camera, the operator viewing the live-view image cannot recognize such a situation that the imaging lens capturing the other of the parallax images, which is not displayed as the live-view image, is covered by a finger.

In order to address these problems, Patent Document 1 has proposed to determine whether or not there is an area covered by a finger in each parallax image captured with a stereoscopic camera, and if there is an area covered by a finger, to highlight the identified area covered by a finger.

Patent Document 1 teaches the following three methods as specific methods for determining the area covered by a finger. In the first method, a result of photometry by a photometric device is compared with a result of photometry by an image pickup device for each parallax image, and if the difference is equal to or greater than a predetermined value, it is determined that there is an area covered by a finger in the photometry unit or the imaging unit. In the second method, for the plurality of parallax images, if there is a local abnormality in the AF evaluation value, the AE evaluation value and/or the white balance of each image, it is determined that there is an area covered by a finger. The third method uses a stereo matching technique, where feature points are extracted from one of the parallax images, and corresponding points corresponding to the feature points are extracted from the other of the parallax images, and then, an area in which no corresponding point is found is determined to be an area covered by a finger.

Japanese Unexamined Patent Publication No. 2004-040712 (hereinafter, Patent Document 2) teaches a method for determining an area covered by a finger for use with single-lens cameras. Specifically, a plurality of live-view images are obtained in time series, and temporal variation of the position of a low-luminance area is captured, so that a non-moving low-luminance area is determined to be an area covered by a finger (which will hereinafter be referred to as “fourth method”) . Patent Document 2 also teaches another method for determining an area covered by a finger, wherein, based on temporal variation of contrast in a predetermined area of images used for AF control, which are obtained in time series while moving the position of a focusing lens, if the contrast value of the predetermined area continues to increase as the lens position approaches the proximal end, the predetermined area is determined to be an area covered by a finger (which will hereinafter be referred to as “fifth method”).

However, the above-described first determining method is only applicable to cameras that includes the photometric devices separately from the image pickup devices. The above-described second, fourth and fifth determining methods make the determination as to whether there is an area covered by a finger based only on one of the parallax images. Therefore, depending on the state of an object to be captured (such as a subject), such as in a case where there is an object in the foreground at the marginal area of the imaging range, and the main subject farther from the camera than the object is at the central area of the imaging range, it may be difficult to achieve a correct determination of an area covered by a finger. Further, the stereo matching technique used in the above-described third determining method requires a large amount of computation, resulting in increased processing time. Also, the above-described fourth determining method requires continuously analyzing the live-view images in time series and making the determination as to whether or not there is an area covered by a finger, resulting in increased calculation cost and power consumption.

### SUMMARY OF THE INVENTION

In view of the above-described circumstances, the present invention is directed to allowing determining whether or not there is an obstacle, such as a finger, in an imaging range of imaging means of a stereoscopic imaging device with higher accuracy and at lower calculation cost and power consumption.

An aspect of a stereoscopic imaging device according to the invention is a stereoscopic imaging device comprising: a plurality of imaging means for capturing a subject and outputting captured images, the imaging means including imaging optical systems positioned to allow stereoscopic display of the subject using the captured images outputted from the imaging means; index value obtaining means for obtaining a predetermined index value for each of a plurality of subranges of each imaging range of each imaging means; and obstacle determining means for comparing the index values of each set of the subranges at mutually corresponding positions in the imaging ranges of the different plurality of imaging means with each other, and if a difference between the index values in the imaging ranges of the different plurality of imaging means is large enough to satisfy a predetermined criterion, determining that the imaging range of at least one of the imaging means contains an obstacle that is close to the imaging optical system of the at least one of the imaging means.

An aspect of an obstacle determining method according to the invention is an obstacle determining method for use with a stereoscopic imaging device including a plurality of imaging means for capturing a subject and outputting captured images, the imaging means including imaging optical systems positioned to allow stereoscopic display of the subject using the captured images outputted from the imaging means, the method being used to determine whether or not an obstacle is contained in an imaging range of at least one of the imaging means, and the method comprising the steps of: obtaining a predetermined index value for each of a plurality of subranges of each imaging range of each imaging means; and comparing the index values of each set of the subranges at mutually corresponding positions in the imaging ranges of the different plurality of imaging means with each other, and if a difference between the index values in the imaging ranges of the different plurality of imaging means is large enough to satisfy a predetermined criterion, determining that the imaging range of at least one of the imaging means contains an obstacle that is close to the imaging optical system of the at least one of the imaging means.

An aspect of an obstacle determination program according to the invention is an obstacle determination program capable of being incorporated in a stereoscopic imaging device including a plurality of imaging means for capturing a subject and outputting captured images, the imaging means including imaging optical systems positioned to allow stereoscopic display of the subject using the captured images outputted from the imaging means, the program causing the stereoscopic imaging device to execute the steps of: obtaining a predetermined index value for each of a plurality of subranges of each imaging range of each imaging means; and comparing the index values of each set of the subranges at mutually corresponding positions in the imaging ranges of the different plurality of imaging means with each other, and if a difference between the index values in the imaging ranges of the different plurality of imaging means is large enough to satisfy a predetermined criterion, determining that the imaging range of at least one of the imaging means contains an obstacle that is close to the imaging optical system of the at least one of the imaging means.

Further, an aspect of an obstacle determination device of the invention includes: index value obtaining means for obtaining, from a plurality of captured images for stereoscopically displaying a main subject obtained by capturing the main subject from different positions using imaging means, or from accompanying information of the captured images, a predetermined index value for each of subranges of each imaging range for capturing each captured image; and determining means for comparing the index values of each set of the subranges at mutually corresponding positions in the imaging ranges of the different plurality of captured images with each other, and if a difference between the index values in the imaging ranges of the different plurality of captured images is large enough to satisfy a predetermined criterion, determining that the imaging range of at least one of the captured images contains an obstacle that is close to an imaging optical system of the imaging means.

The obstacle determination device of the invention may be incorporated into an image display device, a photo printer, etc., for performing stereoscopic display or output.

Specific examples of the “obstacle” herein include objects unintentionally contained in a captured image, such as a finger or a hand of the operator, an object (such as a strap of a mobile phone) held by the operator during an imaging operation and accidentally entering the angle of view of the imaging unit, etc.

The size of the “subrange” may be theoretically and/or experimentally and/or empirically derived based on a distance between the imaging optical systems, etc.

Specific examples of a method for obtaining the “predetermined index value” include the following methods:

(1) Each imaging means is configured to perform photometry at a plurality of points or areas in the imaging range thereof to determine an exposure for capturing an image using photometric values obtained by the photometry, and the photometric value of each subrange is obtained as the index value.
(2) A luminance value of each subrange is calculated from each captured image, and the calculated luminance value is obtained as the index value.
(3) Each imaging means is configured to perform focus control of the imaging optical system of the imaging means based on AF evaluation values at the plurality of points or areas in the imaging range thereof, and the AF evaluation value of each subrange is obtained as the index value.
(4) A high spatial frequency component that is high enough to satisfy predetermined criterion is extracted from each of the captured images, and the amount of the high frequency component of each subrange is obtained as the index value.
(5) Each imaging means is configured to perform automatic white balance control of the imaging means based on color information values at the plurality of points or areas in the imaging range thereof, and the color information value of each subrange is obtained as the index value.
(6) A color information value of each subrange is calculated from each captured image, and the color information value is obtained as the index value. The color information value may be of any of various color spaces.

With respect to the above-described method (1) , (3) or (5), each subrange may include two or more of the plurality of points or areas in the imaging range, at which the photometric values, the AF evaluation values or the color information values are obtained, and the index value of each subrange may be calculated based on the index values at the points or areas in the subrange. Specifically, the index value of each subrange may be a representative value, such as a mean value or median value, of the index values at the points or areas in the subrange.

Further, the imaging means may output images captured by actual imaging and output images captured by preliminary imaging that is performed prior to the actual imaging for determining imaging conditions for the actual imaging, and the index values may be obtained in response to the preliminary imaging. For example, in the case where the above-described method (1) , (3) or (5) is used, the imaging means may perform the photometry or calculate the AF evaluation values or the color information values in response to an operation by the operator to perform the preliminary imaging. On the other hand, in the case where the above-described method (2) (4) or (6), the index values may be obtained based on the images captured by the preliminary imaging.

With respect to the description “comparing the index values of each set of the subranges at mutually corresponding positions in the imaging ranges of the different plurality of imaging means with each other”, the subranges to be compared belong to the imaging ranges of the different plurality of imaging means, and the subranges to be compared are at mutually corresponding positions in the imaging ranges. The description “mutually corresponding positions in the imaging ranges” refers to that the subranges have positional coordinates that agree with each other when a coordinate system where the upper-left corner of the range is the origin, the rightward direction is the x-axis positive direction and the downward direction is the y-axis positive direction, for example, is provided for each imaging range. The correspondence between the positions of the subranges in the imaging ranges may be found as described above after a parallax control to provide a parallax of substantially 0 of the main subject in the captured images outputted from the imaging means is performed (after the correspondence between positions in the imaging ranges is controlled).

The description “if a difference between the index values in the imaging ranges of the different plurality of imaging means is large enough to satisfy a predetermined criterion” refers to that there is a significant difference between the index values in the imaging ranges of the different plurality of imaging means as a whole . That is, the “predetermined criterion” refers to a criterion for judging the difference between the index values of each set of the subranges in a comprehensive way for the entire imaging ranges. A specific example of the case where “a difference between the index values in the imaging ranges of the different plurality of imaging means is large enough to satisfy a predetermined criterion” is that the number of sets of the mutually corresponding subranges in the imaging ranges of the different plurality of imaging means, each set having an absolute value of a difference or a ratio between the index values greater than a predetermined threshold, is equal to or greater than another predetermined threshold.

In the invention, the central area of each imaging range may not be processed during the above-described operations to obtain the index values and/or to determine whether or not an obstacle is contained.

In the invention, two or more types of index values may be obtained. In this case, the above-described comparison may be performed based on each of the two or more types of index values, and if a difference based on at least one of the index values is large enough to satisfy a predetermined criterion, it may be determined that the imaging range of at least one of the imaging means contains an obstacle. Alternatively, if differences based on two or more of the index values are large enough to satisfy predetermined criteria, it may be determined that the imaging range of at least one of the imaging means contains an obstacle. In the invention, if it is determined that an obstacle is contained in the imaging range, a notification to that effect may be made.

According to the present invention, a predetermined index value is obtained for each of subranges of the imaging range of each imaging means of the stereoscopic imaging device, and the index values of each set of the subranges at mutually corresponding positions in the imaging ranges of the different plurality of imaging means are compared with each other. Then, if a difference between the index values in the imaging ranges is large enough to satisfy a predetermined criterion, it is determined that the imaging range of at least one of the imaging means contains an obstacle.

Since the determination as to whether or not there is an obstacle is achieved based on the comparison of the index values between the imaging ranges of the different plurality of imaging means, it is not necessary to provide photometric devices separately from the image pickup devices, which are necessary in the first determining method described above as the related art, and this provides higher freedom in hardware design.

Further, the presence of areas containing an obstacle is more notably shown as a difference between the images captured by the different plurality of imaging means, and this difference is larger than an error appearing in the images due to a parallax between the imaging means. Therefore, by comparing the index values between the imaging ranges of the different plurality of imaging means, as in the present invention, the determination of areas containing an obstacle can be achieved with higher accuracy than a case where the determination is performed using only one captured image, such as the case where the above-described second, fourth or fifth determining method is used.

Still further, in the present invention, the index values of each set of the subranges at mutually corresponding positions in the imaging ranges are compared with each other. Therefore, calculation cost and power consumption can be reduced from those in a case where matching between captured images is performed based on features of the contents in the images, as in the above-described third determining method.

As described above, according to the present invention, a stereoscopic imaging device that is able to determine whether or not there is an obstacle, such as a finger, in the imaging range of the imaging means with higher accuracy and at lower calculation cost and power consumption is provided. The same advantageous effect is provided by the obstacle determination device of the invention, that is, a stereoscopic image output device incorporating the obstacle determination device of the invention. In the case where the photometric values, the AF evaluation values or the color information values obtained by the imaging means are used as the index values, the numerical values which are usually obtained during an imaging operation by the imaging means are used as the index values. Therefore, it is not necessary to calculate new index values, and this is advantageous in processing efficiency.

In the case where the photometric values or the luminance values are used as the index values, even when an obstacle and the background thereof in the imaging range have similar textures or the same color, a reliable determination that an obstacle is contained can be made based on a difference of brightness between the obstacle and the background in the imaging range.

In the case where the AF evaluation values or the amounts of high frequency component are used as the index values, even when an obstacle and the background thereof in the imaging range have the same level of brightness or the same color, a reliable determination that an obstacle is contained can be made based on a difference of texture between the obstacle and the background in the imaging range.

In the case where the color information values are used as the index values, even when an obstacle and the background thereof in the imaging range have the same level of brightness or similar textures, a reliable determination that an obstacle is contained can be made based on a difference of color between the obstacle and the background in the imaging range.

In the case where two or more types of index values are used, the determination as to whether or not an obstacle is contained can be achieved with higher and more stable accuracy under various conditions of the obstacle and the background in the imaging range by compensating for disadvantages based on characteristics of one type of index value with advantages of other types of index values.

In the case where the size of each subrange is large to some extent, such that each subrange includes a plurality of points or areas, at which the photometric values or the AF evaluation values are obtained by the imaging means, and the index value of each subrange is calculated based on the photometric values or the AF evaluation values at the points or areas in the subrange, an error due to a parallax between the imaging units is diffused in the subrange, and this allows the determination as to whether or not an obstacle is contained with higher accuracy.

In the case where the index values of each set of the subranges at mutually corresponding positions in the imaging ranges of the different plurality of imaging means are compared with each other after a correspondence between positions in the imaging ranges is controlled to provide a parallax of substantially 0 of a main subject in the captured images outputted from the imaging means, a positional offset of the subject between the captured images due to a parallax is reduced. Therefore, the possibility of a difference between the index values of the captured images indicating the presence of an obstacle is increased, thereby allowing the determination as to whether or not there is an obstacle with higher accuracy.

In the case where the central area of each imaging range is not processed during the operations to obtain the index values and/or to determine whether or not an obstacle is contained, accuracy of the determination is improved by not processing the central area, which is less likely to contain an obstacle, since, if there is an obstacle that is close to the imaging optical system of the imaging means, at least the marginal area of the imaging range contains the obstacle.

In the case where the index values are obtained in response to the preliminary imaging for determining imaging conditions for the actual imaging, which is performed prior to the actual imaging, the presence of an obstacle can be determined before the actual imaging. Therefore, by making a notification to that effect, for example, failure of the actual imaging can be avoided before the actual imaging is performed. Even in a case where the index values are obtained in response to the actual imaging, the operator may be notified of the fact that an obstacle is contained, for example, so that the operator can recognize the failure of the actual imaging immediately and can quickly retake another picture.

### BRIEF DESCRIPTION OF THE DRAWINGS

FIG. 1 is a front side perspective view of a stereoscopic camera according to embodiments of the invention,

FIG. 2 is a rear side perspective view of the stereoscopic camera,

FIG. 3 is a schematic block diagram illustrating the internal configuration of the stereoscopic camera,

FIG. 4 is a diagram illustrating the configuration of each imaging unit of the stereoscopic camera,

FIG. 5 is a diagram illustrating a file format of a stereoscopic image file,

FIG. 6 is a diagram illustrating the structure of a monitor,

FIG. 7 is a diagram illustrating the structure of a lenticular sheet,

FIG. 8 is a diagram for explaining three-dimensional processing,

FIG. 9A is a diagram illustrating a parallax image containing an obstacle,

FIG. 9B is a diagram illustrating a parallax image containing no obstacle,

FIG. 10 is a diagram illustrating an example of a displayed warning message,

FIG. 11 is a block diagram illustrating details of an obstacle determining unit according to first, third, fourth and sixth embodiments of the invention,

FIG. 12A is a diagram illustrating one example of photometric values of areas in an imaging range that contains an obstacle,

FIG. 12B is a diagram illustrating one example of photometric values of areas in an imaging range that contains no obstacle,

FIG. 13 is a diagram illustrating one example of differential values between the photometric values of mutually corresponding areas,

FIG. 14 is a diagram illustrating one example of absolute values of the differential values between the photometric values of mutually corresponding areas,

FIG. 15 is a flow chart illustrating the flow of an imaging process according to the first, third, fourth and sixth embodiments of the invention,

FIG. 16 is a block diagram illustrating details of an obstacle determining unit according to second and fifth embodiments of the invention,

FIG. 17A is a diagram illustrating one example of a result of averaging the photometric values of each set of four neighboring areas in an imaging range that contains an obstacle,

FIG. 17B is a diagram illustrating one example of a result of averaging the photometric values of each set of four neighboring areas in an imaging range that contains no obstacle,

FIG. 18 is a diagram illustrating one example of differential values between the mean photometric values of mutually corresponding combined areas,

FIG. 19 is a diagram illustrating one example of absolute values of the differential values between the mean photometric values of mutually corresponding combined areas,

FIG. 20 is a flow chart illustrating the flow of an imaging process according to the second and fifth embodiments of the invention,

FIG. 21 is a diagram illustrating one example of central areas which are not counted,

FIG. 22A is a diagram illustrating one example of AF evaluation values of areas in an imaging range that contains an obstacle,

FIG. 22B is a diagram illustrating one example of AF evaluation values of areas in an imaging range that contains no obstacle,

FIG. 23 is a diagram illustrating one example of differential values between the AF evaluation values of mutually corresponding areas,

FIG. 24 is a diagram illustrating one example of absolute values of the differential values between the AF evaluation values of mutually corresponding areas,

FIG. 25A is a diagram illustrating one example of a result of averaging the AF evaluation values of each set of four neighboring areas in an imaging range that contains an obstacle,

FIG. 25B is a diagram illustrating one example of a result of averaging the AF evaluation values of each set of four neighboring areas in an imaging range that contains no obstacle,

FIG. 26 is a diagram illustrating one example of differential values between the mean AF evaluation values of mutually corresponding combined areas,

FIG. 27 is a diagram illustrating one example of absolute values of the differential values between the mean AF evaluation values of mutually corresponding combined areas,

FIG. 28 is a diagram illustrating another example of the central areas which are not counted,

FIG. 29 is a block diagram illustrating details of an obstacle determining unit according to seventh and ninth embodiments of the invention,

FIG. 30A is a diagram illustrating an example of first color information values of areas in an imaging range in a case where an obstacle is contained at a lower part of an imaging optical system of the imaging unit,

FIG. 30B is a diagram illustrating an example of first color information values of areas in an imaging range that contains no obstacle,

FIG. 30C is a diagram illustrating an example of second color information values of areas in an imaging range in a case where an obstacle is contained at a lower part of the imaging optical system of the imaging unit,

FIG. 30D is a diagram illustrating an example of second color information values of areas in an imaging range that contains no obstacle,

FIG. 31 is a diagram illustrating one example of distances between color information values of mutually corresponding areas,

FIG. 32 is a flow chart illustrating the flow of an imaging process according to the seventh and ninth embodiments of the invention,

FIG. 33 is a block diagram illustrating details of an obstacle determining unit according to an eighth embodiment of the invention,

FIG. 34A is a diagram illustrating an example of a result of averaging the first color information values of each set of four neighboring areas in an imaging range in the case where an obstacle is contained at a lower part of the imaging optical system of the imaging unit,

FIG. 34B is a diagram illustrating an example of a result of averaging the first color information values of each set of four neighboring areas in an imaging range that contains no obstacle,

FIG. 34C is a diagram illustrating an example of a result of averaging the second color information values of each set of four neighboring areas in an imaging range in the case where an obstacle is contained at a lower part of the imaging optical system of the imaging unit,

FIG. 34D is a diagram illustrating an example of a result of averaging the second color information values of each set of four neighboring areas in an imaging range that contains no obstacle,

FIG. 35 is a diagram illustrating one example of distances between the color information values of mutually corresponding combined areas,

FIG. 36 is a flow chart illustrating the flow of an imaging process according to the eighth embodiment of the invention,

FIG. 37 is a diagram illustrating another example of the central areas which are not counted,

FIG. 38 is a block diagram illustrating details of an obstacle determining unit according to tenth and eleventh embodiments of the invention,

FIG. 39A is a flow chart illustrating the flow of an imaging process according to the tenth embodiment of the invention,

FIG. 39B is a flow chart illustrating the flow of the imaging process according to the tenth embodiment of the invention (continued),

FIG. 40A is a flow chart illustrating the flow of an imaging process according to the eleventh embodiment of the invention,

FIG. 40B is a flow chart illustrating the flow of the imaging process according to the eleventh embodiment of the invention (continued).

### DESCRIPTION OF THE PREFERRED EMBODIMENTS

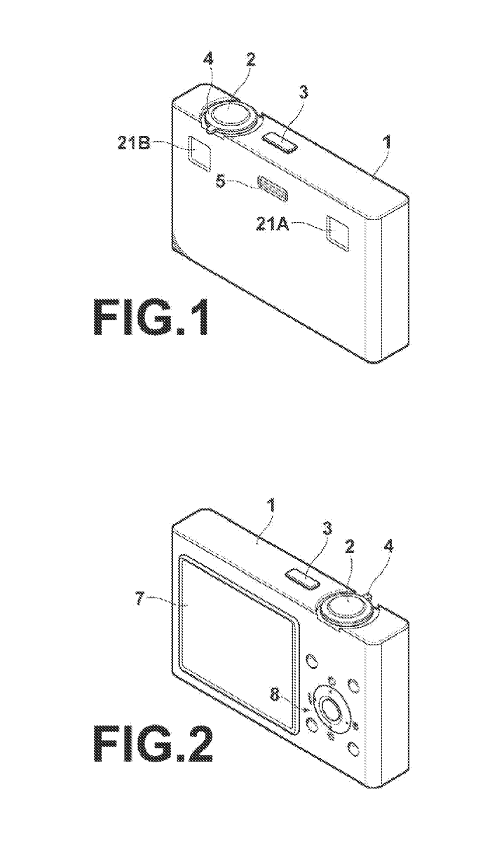

Hereinafter, embodiments of the present invention will be described with reference to the drawings. FIG. 1 is a front side perspective view of a stereoscopic camera according to the embodiments of the invention, and FIG. 2 is rear side perspective view of the stereoscopic camera. As shown in FIG. 1, the stereoscopic camera 1 includes, at the upper portion thereof, a release button 2, a power button 3 and a zoom lever 4. The stereoscopic camera 1 includes, at the front side thereof, a flash lamp 5 and lenses of two imaging units 21A and 21B, and also includes, at the rear side thereof, a liquid crystal monitor (which will hereinafter simply be referred to as “monitor”) 7 for displaying various screens, and various operation buttons 8.

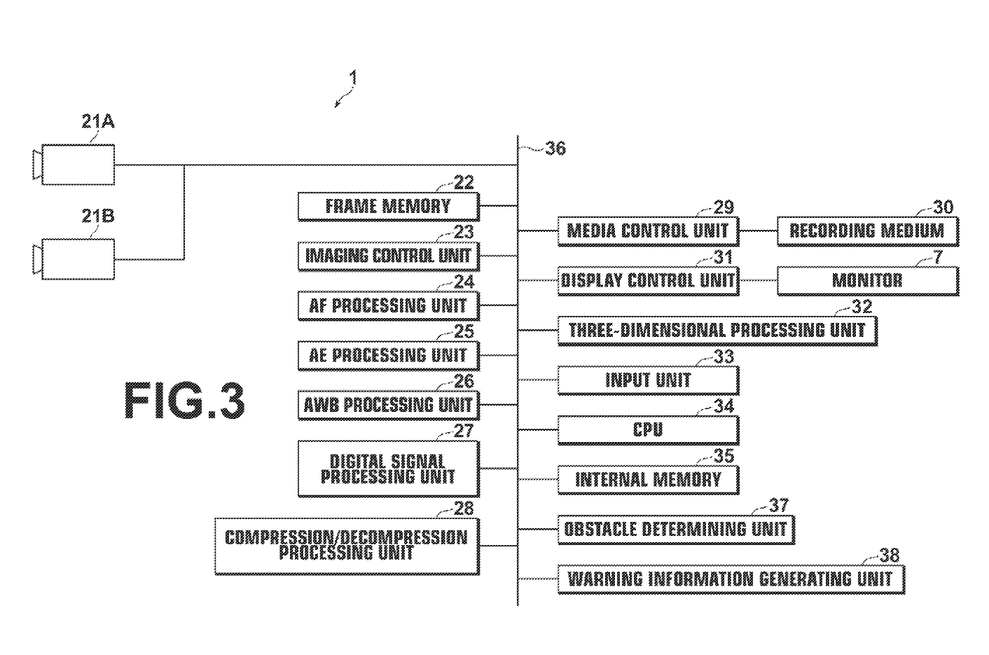

FIG. 3 is a schematic block diagram illustrating the internal configuration of the stereoscopic camera 1. As shown in FIG. 3, the stereoscopic camera 1 according to the embodiments of the invention includes two imaging units 21A and 21B, a frame memory 22, an imaging control unit 23, an AF processing unit 24, an AE processing unit 25, an AWB processing unit 26, a digital signal processing unit 27, a three-dimensional processing unit 32, a display control unit 31, a compression/decompression processing unit 28, a media control unit 29, an input unit 33, a CPU 34, an internal memory 35 and a data bus 36, as with known stereoscopic cameras. The imaging units 21A and 21B are positioned to have a convergence angle with respect to a subject and a predetermined base line length. Information of the angle of convergence and the base line length are stored in the internal memory 27.

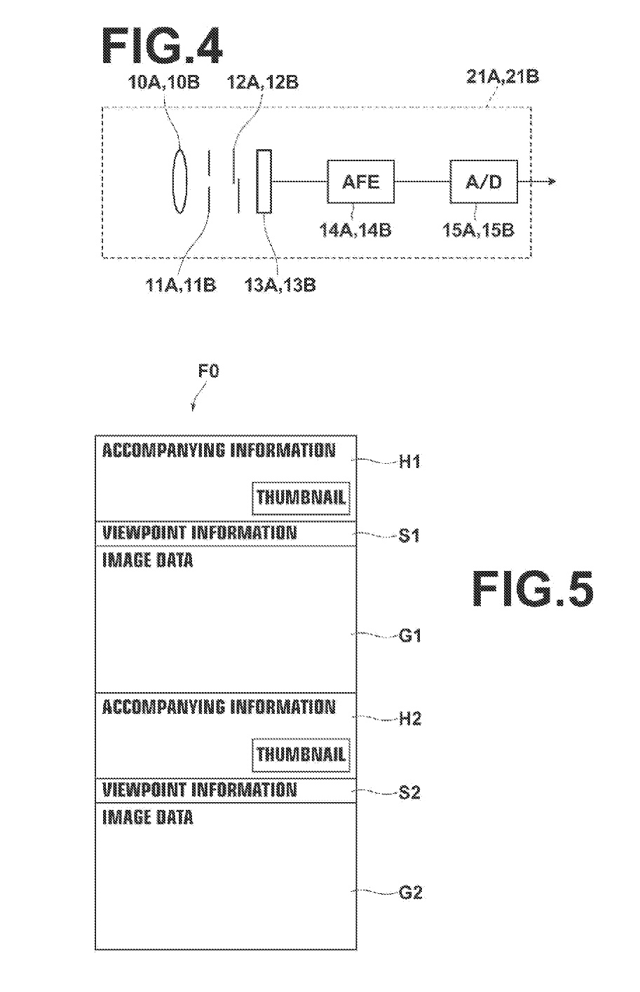

FIG. 4 is a diagram illustrating the configuration of each imaging unit 21A, 21B. As shown in FIG. 4, each imaging unit 21A, 215 includes a lens 10A, 10B, an aperture diaphragm 11A, 11B, a shutter 12A, 12B, an image pickup device 13A, 13B, an analog front end (AFE) 14A, 14B and an A/D converter 15A, 15B, as with known stereoscopic cameras.

Each lens 10A, 10B is formed by a plurality of lenses having different functions, such as a focusing lens used to focus on the subject and a zoom lens used to achieve a zoom function. The position of each lens is controlled by a lens driving unit (not shown) based on focus data obtained through AF processing performed by the imaging control unit 22 and zoom data obtained upon operation of the zoom lever 4.

Aperture diameters of the aperture diaphragms 11A and 115 are controlled by an aperture diaphragm driving unit (not shown) based on aperture value data obtained through AE processing performed by the imaging control unit 22.

The shutters 12A and 12B are mechanical shutters, and are driven by a shutter driving unit (not shown) according to a shutter speed obtained through the AE processing.

Each image pickup device 13A, 13B includes a photoelectric surface, on which a large number of light-receiving elements are arranged two-dimensionally. Light from the subject is focused on each photoelectric surface and is subjected to photoelectric conversion to provide an analog imaging signal. Further, a color filter formed by regularly arranged R, G and B color filters is disposed on the front side of each image pickup device 13A, 13B.

The AFEs 14A and 14B process the analog imaging signals fed from the image pickup devices 13A and 13B to remove noise from the analog imaging signals and adjust gain of the analog imaging signals (this operation is hereinafter referred to as “analog processing”).

The A/D converting units 15A and 15B convert the analog imaging signals, which have been subjected to the analog processing by the AFEs 14A and 14B, into digital signals. It should be noted that the image represented by digital image data obtained by the imaging unit 21A is referred to as a first image G1, and the image represented by digital image data obtained by the imaging unit 21B is referred to as a second image G2.

The frame memory 22 is a work memory used to carry out various types of processing, and the image data representing the first and second images G1 and G2 obtained by the imaging units 21A and 21B is inputted thereto via an image input controller (not shown).

The imaging control unit 23 controls timing of operations performed by the individual units. Specifically, when the release button 2 is fully pressed, the imaging control unit 23 instructs the imaging units 21A and 21B to perform actual imaging to obtain actual images of the first and second images G1 and G2. It should be noted that, before the release button 2 is operated, the imaging control unit 23 instructs the imaging units 21A and 21B to successively obtain live view images, which have fewer pixels than the actual images of the first and second images G1 and G2, at a predetermined time interval (for example, at an interval of 1/30 seconds) for checking imaging range.

When the release button 2 is half-pressed, the imaging units 21A and 21B obtain preliminary images. Then, the AF processing unit 24 calculates AF evaluation values based on image signals of the preliminary images, determines a focused area and a focal position of each lens 10A, 10B based on the AF evaluation values, and outputs them to the imaging units 21A and 21B. As a method used to detect the focal positions through the AF processing, a passive method is used, where the focus position is detected based on the characteristics that an image containing a desired subject being focused has a higher contrast value. For example, the AF evaluation value may be an output value from a predetermined high-pass filter. In this case, a larger value indicates higher contrast.

The AE processing unit 25 in this example uses multi-zone metering, where an imaging range is divided into a plurality of areas and photometry is performed on each area using the image signal of each preliminary image to determine exposure (an aperture value and a shutter speed) based on photometric values of the areas. The determined exposure is outputted to the imaging units 21A and 21B.

The AWB processing unit 26 calculates, using R, G and B image signals of the preliminary images, a color information value for automatic white balance control for each of the divided areas of the imaging range.

The AF processing unit 24, the AE processing unit 25 and the AWB processing unit 26 may sequentially perform their operations for each imaging unit, or these processing units may be provided for each imaging unit to perform the operations in parallel.

The digital signal processing unit 27 applies image processing, such as white balance control, tone correction, sharpness correction and color correction, to the digital image data of the first and second images G1 and G2 obtained by the imaging units 21A and 21B. In this description, the first and second images which have been processed by the digital signal processing unit 27 are also denoted by the same reference symbols G1 and G2 as the unprocessed first and second images.

The compression/decompression unit 28 applies compression processing according to a certain compression format, such as JPEG, to the image data representing the actual images of the first and second images G1 and G2 processed by the digital signal processing unit 27, and generates a stereoscopic image file F0. The stereoscopic image file F0 contains the image data of first and second images G1 and G2, and stores accompanying information, such as the base line length, the angle of convergence and imaging time and date, and viewpoint information representing viewpoint positions based on the Exif format, or the like.

FIG. 5 is a diagram illustrating a file format of the stereoscopic image file. As shown in FIG. 5, the stereoscopic image file F0 stores accompanying information H1 of the first image G1, viewpoint information S1 of the first image G1, the image data of the first image G1 (the image data is also denoted by the reference symbol G1), accompanying information H2 of the second image G2, viewpoint information S2 of the second image G2 and the image data of the second image G2. Although not shown in the drawing, pieces of information representing the start position and the end position of data are included before and after each of the accompanying information, the viewpoint information and the image data of the first and second images G1 and G2. Each of the accompanying information H1, H2 contains information of the imaging date, the base line length and the angle of convergence of the first and second images G1 and G2. Each of the accompanying information H1, H2 also contains a thumbnail image of each of the first and second images G1 and G2. As the viewpoint information, a number assigned to each viewpoint position from the viewpoint position of the leftmost imaging unit, for example, may be used.

The media control unit 29 accesses a recording medium 30 and controls writing and reading of the image file, etc.

The display control unit 31 causes the first and second images G1 and G2 stored in the frame memory 22 and a stereoscopic image GR generated from the first and second images G1 and G2 to be displayed on the monitor 7 during imaging, or causes the first and second images G1 and G2 and the stereoscopic image GR recorded in the recording medium 30 to be displayed on the monitor 7.

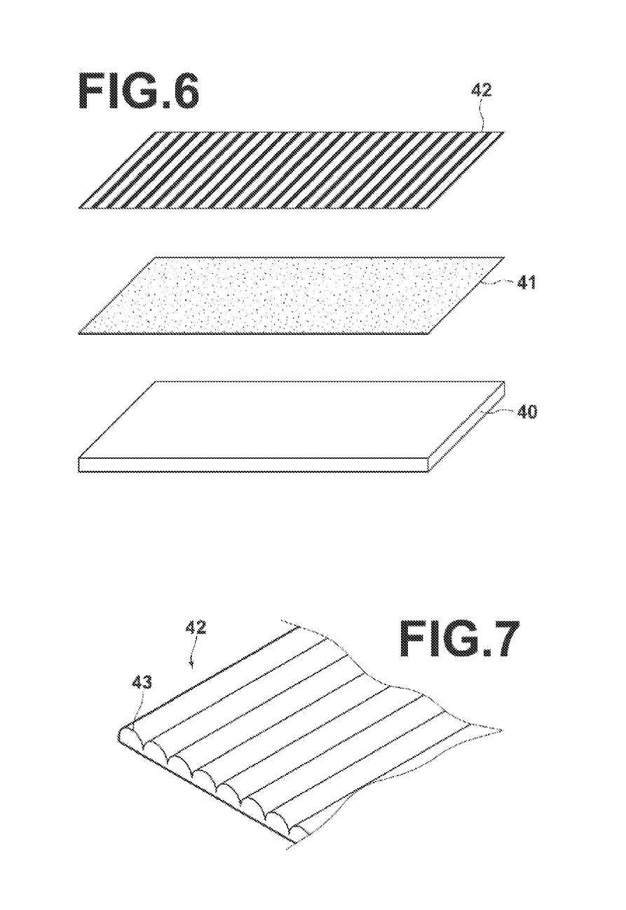

FIG. 6 is a diagram illustrating the structure of the monitor 7. As shown in FIG. 6, the monitor 7 is formed by stacking, on a backlight unit 40 that includes LEDs for emitting light, a liquid crystal panel 41 for displaying various screens, and attaching a lenticular sheet 42 on the liquid crystal panel 41.

FIG. 7 is a diagram illustrating the structure of the lenticular sheet. As shown in FIG. 7, the lenticular sheet 42 is formed by arranging a plurality of cylindrical lenses 43 side by side.

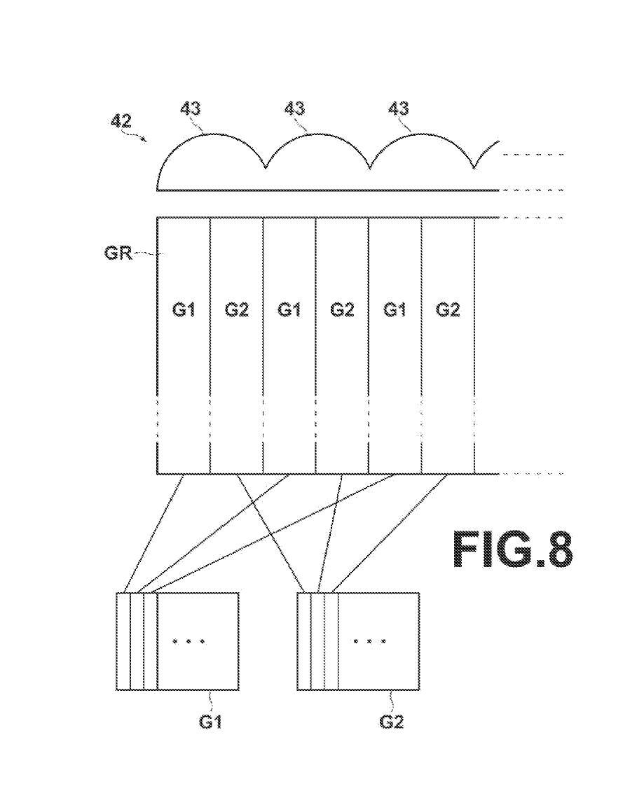

In order to stereoscopically display the first and second images G1 and G2 on the monitor 7, the three-dimensional processing unit 32 applies three-dimensional processing to the first and second images G1 and G2 to generate the stereoscopic image GR. FIG. 8 is a diagram for explaining the three-dimensional processing. As shown in FIG. 8, the three-dimensional processing unit 32 performs the three-dimensional processing by cutting the first and second images G1 and G2 into vertical strips and alternately arranging the strips of the first and second images G1 and G2 at positions corresponding to the individual cylindrical lenses 43 of the lenticular sheet 42 to generate the stereoscopic image GR. In order to provide an appropriate stereoscopic effect of the stereoscopic image GR, the three-dimensional processing unit 32 may correct the parallax between the first and second images G1 and G2. The parallax can be calculated as a difference between pixel positions of the subject contained in both the first and second images G1 and G2 in the horizontal direction of the images. By controlling the parallax, the subject contained in the stereoscopic image GR can be provided with an appropriate stereoscopic effect.

The input unit 33 is an interface that is used when the operator operates the stereoscopic camera 1. The release button 2, the zoom lever 4, the various operation button 8, etc., correspond to the input unit 33.

The CPU 34 controls the components of the main body of the stereoscopic camera 1 according to signals inputted from the above-described various processing units.

The internal memory 35 stores various constants to be set in the stereoscopic camera 1, programs executed by the CPU 34, etc.

The data bus 36 is connected to the units forming the stereoscopic camera 1 and the CPU 34, and communicates various data and information in the stereoscopic camera 1.

The stereoscopic camera 1 according to the embodiments of the invention further includes an obstacle determining unit 37 for implementing an obstacle determination process of the invention and a warning information generating unit 38, in addition to the above-described configuration.

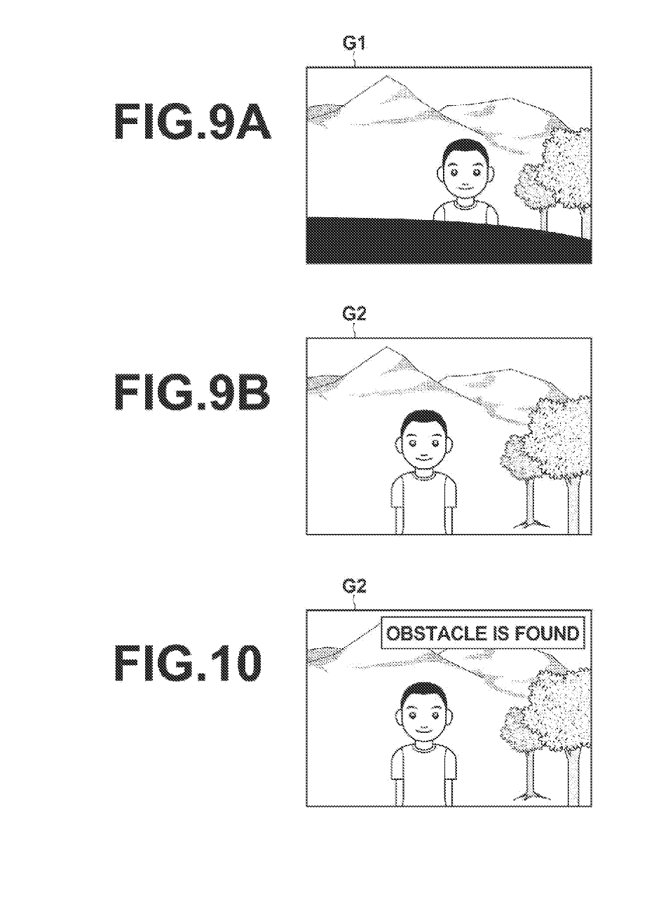

When the operator captures an image using the stereoscopic camera 1 according to this embodiment, the operator performs framing while viewing a stereoscopic live-view image displayed on the monitor 7. At this time, for example, a finger of the left hand of the operator holding the stereoscopic camera 1 may enter the angle of view of the imaging unit 21A and cover a part of the angle of view of the imaging unit 21A. In such a case, as shown in FIG. 9A as an example, the finger is contained as an obstacle at the lower part of the first image G1 obtained by the imaging unit 21A, and the background at the part cannot be seen. On the other hand, as shown in FIG. 9B as an example, the second image G2 obtained by the imaging unit 21B contain no obstacle.

In such a situation, if the stereoscopic camera 1 is configured to two-dimensionally display the first image G1 on the monitor 7, the operator can recognize the finger, or the like, covering the imaging unit 21A by viewing the live-view image on the monitor 7. However, if the stereoscopic camera 1 is configured to two-dimensionally display the second image G2 on the monitor 7, the operator cannot recognize the finger, or the like, covering the imaging unit 21A by viewing the live-view image on the monitor 7. Further, in a case where the stereoscopic camera 1 is configured to stereoscopically display the stereoscopic image GR generated from the first and second images G1 and G2 on the monitor 7, information of the background of the area in the first image covered by the finger, or the like, is compensated for with the second image G2, and the operator cannot easily recognize that the finger, or the like, is covering the imaging unit 21A by viewing the live-view image on the monitor 7.

Therefore, the obstacle determining unit 37 determines whether or not an obstacle, such as a finger, is contained in one of the first and second images G1 and G2.

If it is determined by the obstacle determining unit 37 that an obstacle is contained, the warning information generating unit 38 generates a warning message to that effect, such as a text message “obstacle is found”. As shown in FIG. 10 as an example, the generated warning message is superimposed on the first or second image G1, G2 to be displayed on the monitor 7. The warning message presented to the operator may be in the form of text information, as described above, or a warning in the form of a sound may be presented to the operator via a sound output interface, such as a speaker (not shown), of the stereoscopic camera 1.

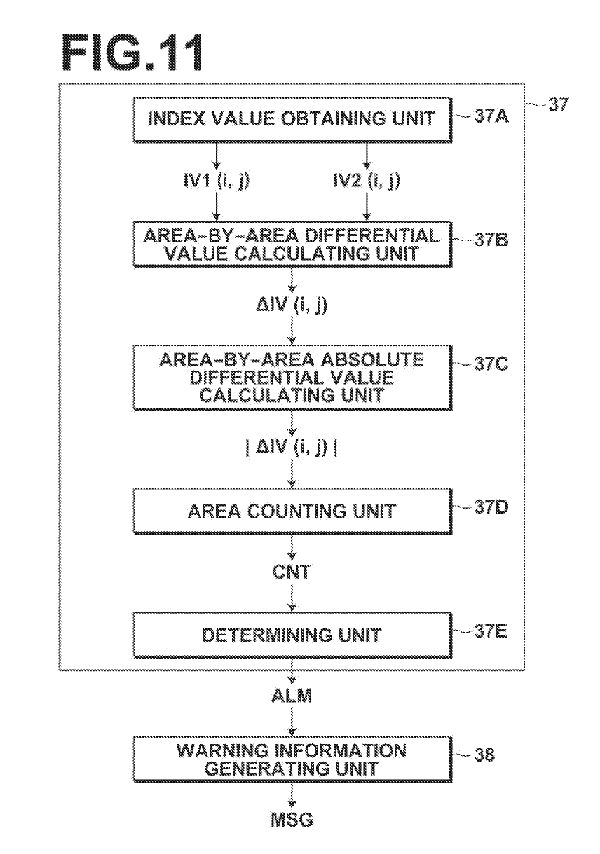

FIG. 11 is a block diagram schematically illustrating the configuration of the obstacle determining unit 37 and the warning information generating unit 38 according to the first embodiment of the invention. As shown in the drawing, in the first embodiment of the invention, the obstacle determining unit 37 includes an index value obtaining unit 37A, an area-by-area differential value calculating unit 37B, an area-by-area absolute differential value calculating unit 37C, an area counting unit 37D and a determining unit 37E. These processing units of the obstacle determining unit 37 may be implemented as software by a built-in program that is executed by the CPU 34 or a general-purpose processor for the obstacle determining unit 37, or may be implemented as hardware in the form of a special-purpose processor for the obstacle determining unit 37. In a case where the processing units of the obstacle determining unit 37 are implemented as software, the above-mentioned program may be provided by updating the firmware in existing stereoscopic cameras.

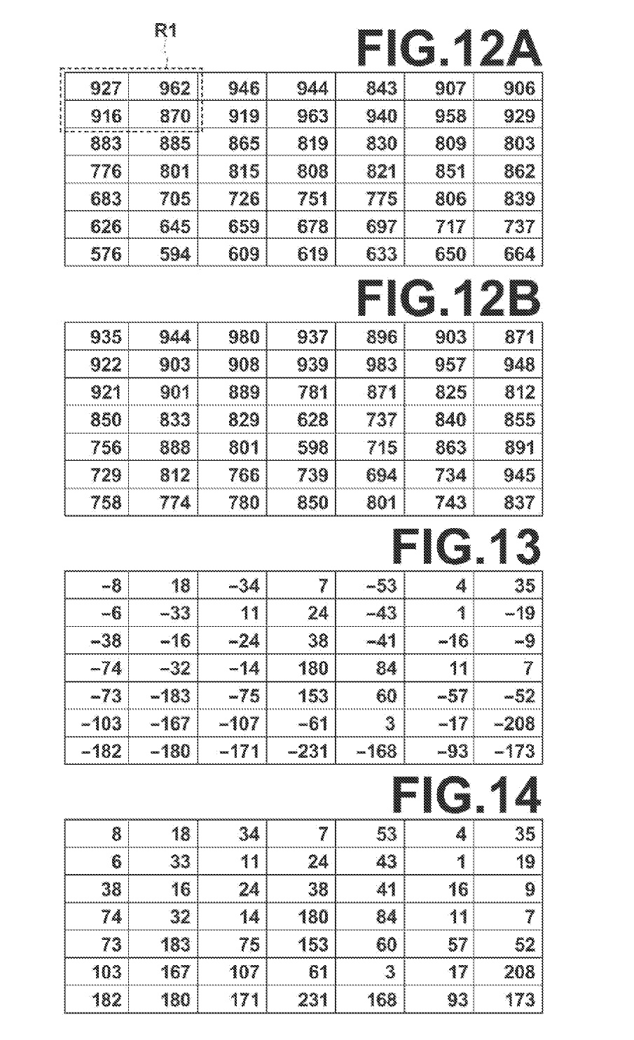

The index value obtaining unit 37A obtains photometric values of the areas in the imaging range of each imaging unit 21A, 21B obtained by the AE processing unit 25. FIG. 12A illustrates one example of the photometric values of the individual areas in the imaging range in a case where an obstacle is contained at the lower part of the imaging optical system of the imaging unit 21A, and FIG. 12B illustrates one example of the photometric values of the individual areas in the imaging range where no obstacle is contained. In these examples, the values are photometric values of 100× precision of 7×7 areas provided by dividing a central 70% area of the imaging range of each imaging unit 21A, 21B. As shown in FIG. 12A, the areas containing an obstacle tend to be darker and have smaller photometric values.

The area-by-area differential value calculating unit 37B calculates a difference between the photometric values of each set of areas at mutually corresponding positions in the imaging ranges. Namely, assuming that the photometric value of an area at the i-th row and the j-th column in the imaging range of the imaging unit 21A is IV1 (i,j), and the photometric value of an area at the i-th row and the j-th column in the imaging range of the imaging unit 21B is IV2 (i,j), a differential value ΔIV (i,j) between the photometric values of the mutually corresponding areas is calculated by the following equation:

ΔIV(i,j)=IV1(i,j)−IV2(i,j)

FIG. 13 shows an example of the differential values ΔIV (i, j) calculated for the mutually corresponding areas with assuming that each photometric value shown in FIG. 12A is IV1 (i,j) and each photometric value shown in FIG. 12B is IV2 (i,j).

The area-by-area absolute differential value calculating unit 37C calculates an absolute value |ΔIV (i,j)| of each differential value ΔIV (i,j). FIG. 14 shows an example of the calculated absolute values of the differential values shown in FIG. 13. As shown in the drawing, in a case where an obstacle covers one of the imaging optical systems of the imaging units, the areas covered by the obstacle in the imaging range has larger absolute values |ΔIV (i,j)|.

The area counting unit 37D compares the absolute values |ΔIV (i,j)| with a predetermined first threshold, and counts a number CNT of areas having absolute values |ΔIV (i,j)| greater than the first threshold. For example, in the case shown in FIG. 14, assuming that the threshold is 100, 13 areas among the 49 areas have absolute values |ΔIV(i,j)| greater than 100.

The determining unit 37E compares the count CNT obtained by the area counting unit 37D with a predetermined second threshold. If the count CNT is greater than the second threshold, the determining unit 37E outputs a signal ALM that requests to output a warning message. For example, in the case shown in FIG. 14, assuming that the second threshold is 5, the count CNT, which is 13, is greater than the second threshold, and therefore the signal ALM is outputted.

The warning information generating unit 38 generates and outputs a warning message MSG in response to the signal ALM outputted from the determining unit 37E.

It should be noted that the first and second thresholds in the above description may be fixed values that are experimentally or empirically determined in advance, or may be set and changed by the operator via the input unit 33.

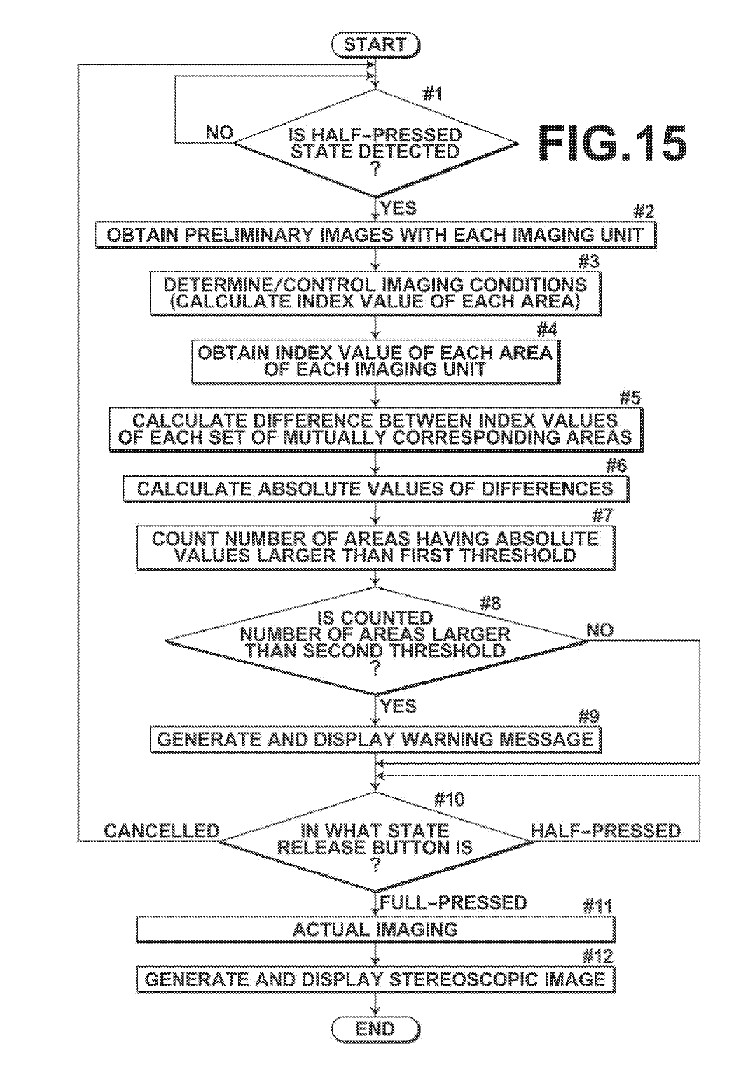

FIG. 15 is a flow chart illustrating the flow of a process carried out in the first embodiment of the invention. First, when the half-pressed state of the release button 2 is detected (#1: YES), the preliminary images G1 and G2 for determining imaging conditions are obtained by the imaging units 21A and 21B, respectively (#2). Then, the AF processing unit 24, the AE processing unit 25 and the AWB processing unit 26 perform operations to determine various imaging conditions, and the components of the imaging units 21A and 21B are controlled according to the determined imaging conditions (#3). At this time, the AE processing unit 25 obtains the photometric values IV1 (i,j), IV2 (i,j) of the individual areas in the imaging ranges of the imaging units 21A and 213.

Then, at the obstacle determining unit 37, the index value obtaining unit 37A obtains the photometric values IV1 (i,j) IV2 (i,j) of the individual areas (#4), the area-by-area differential value calculating unit 37B calculates the differential value ΔIV (i,j) between the photometric values IV1 (i,j) and IV2 (i,j) of each set of areas at mutually corresponding positions between the imaging ranges (#5), and the area-by-area absolute differential value calculating unit 37C calculates the absolute value |ΔIV (i,j)| of each differential value ΔIV (i,j) (#6). Then, the area counting unit 37D counts the number CNT of areas having absolute values |ΔIV (i,j)| greater than the first threshold (#7). If the count CNT is greater than the second threshold (#8: YES) , the determining unit 37E outputs the signal MM that requests to output the warning message, and the warning information generating unit 38 generates the warning message MSG in response to the signal ALM. The generated warning message MSG is displayed with being superimposed on the live-view image currently displayed on the monitor 7 (#9) . In contrast, if the value of count CNT is not greater than the second threshold (#8: NO) , the above-described step #9 is skipped.

Thereafter, when the fully-pressed state of the release button 2 is detected (#10: full-pressed) , the imaging units 21A and 21B perform actual imaging, and the actual images G1 and G2 are obtained (#11). The actual images G1 and G2 are subjected to processing by the digital signal processing unit 27, and then, the three-dimensional processing unit 32 generates the stereoscopic image GR from the first and second images G1 and G2 and outputs the stereoscopic image GR (#12). Then, the series of operations end. It should be noted that, if the release button 2 is held half-pressed in step #10 (#10: half-pressed) , the imaging conditions set in step #3 are maintained to wait further operation of the release button 2, and when the half-pressed state is cancelled (#10: cancelled), the process returns to step #1 to wait the release button 2 to be half-pressed.

As described above, in the first embodiment of the invention, the AE processing unit 25 obtains photometric values of the areas in the imaging ranges of the imaging units 21A and 21B of the stereoscopic camera 1. Using these photometric values, the obstacle determining unit 37 calculates the absolute value of the differential value between the photometric values of each set of areas at mutually corresponding positions in the imaging ranges of the imaging units. Then, the number of areas having the absolute values of the differential values greater than the predetermined first threshold is counted. If the counted number of areas is greater than the predetermined second threshold, it is determined that an obstacle is contained in at least one of the imaging ranges of the imaging units 21A and 21B. This eliminates the necessity of providing photometric devices for the obstacle determination process separately from the image pickup devices, thereby providing higher freedom in hardware design. Further, by comparing the photometric values between the imaging ranges of the different imaging units, the determination as to whether or not there is an obstacle can be achieved with higher accuracy than in a case where areas containing an obstacle are determined from only one image. Still further, since the comparison of the photometric values is performed for each set of areas at mutually corresponding positions in the imaging ranges, calculation cost and power consumption can be reduced from those in a case where matching between captured images is performed based on features of the contents of the images.

Yet further, since the determination as to whether or not there is an obstacle by the obstacle determining unit 37 is performed using the photometric values obtained during a usual imaging operation, it is not necessary to calculate new index values, and this is advantageous in processing efficiency.

Further, the photometric values are used as the index values for the determination as to whether or not there is an obstacle.

Therefore, even when an obstacle and the background thereof in the imaging range have similar textures or the same color, a reliable determination that an obstacle is contained can be made based on a difference of brightness between the obstacle and the background in the imaging range.

Each divided area has a size that is larger enough than a size corresponding to one pixel. Therefore, an error due to a parallax between the imaging units is diffused in the area, and this allows a more accurate determination that an obstacle is contained. It should be noted that the number of divided areas is not limited to 7×7.

Since the obstacle determining unit 37 obtains the photometric values in response to the preliminary imaging that is performed prior to the actual imaging, the determination as to an obstacle covering the imaging unit can be performed before the actual imaging. Then, if there is an obstacle covering the imaging unit, the message generated by the warning information generating unit 38 is presented to the operator, thereby allowing avoiding failure of the actual imaging before the actual imaging is performed.

It should be noted that, although the determination as to whether or not there is an obstacle by the obstacle determining unit 37 is achieved using the photometric values obtained by the AE processing unit 25 in the above-described embodiment, there may be cases where it is impossible to obtain the photometric value for each area in the imaging range, such as when a different exposure system is used. In such cases, each image G1, G2 obtained by each imaging unit 21A, 21B may be divided into a plurality of areas, in the same manner as described above, and a representative value (such as a mean value or a median value) of luminance values for each area may be calculated. In this manner, the same effect as that described above can be provided, except for an additional processing load for calculating the representative values of the luminance values.

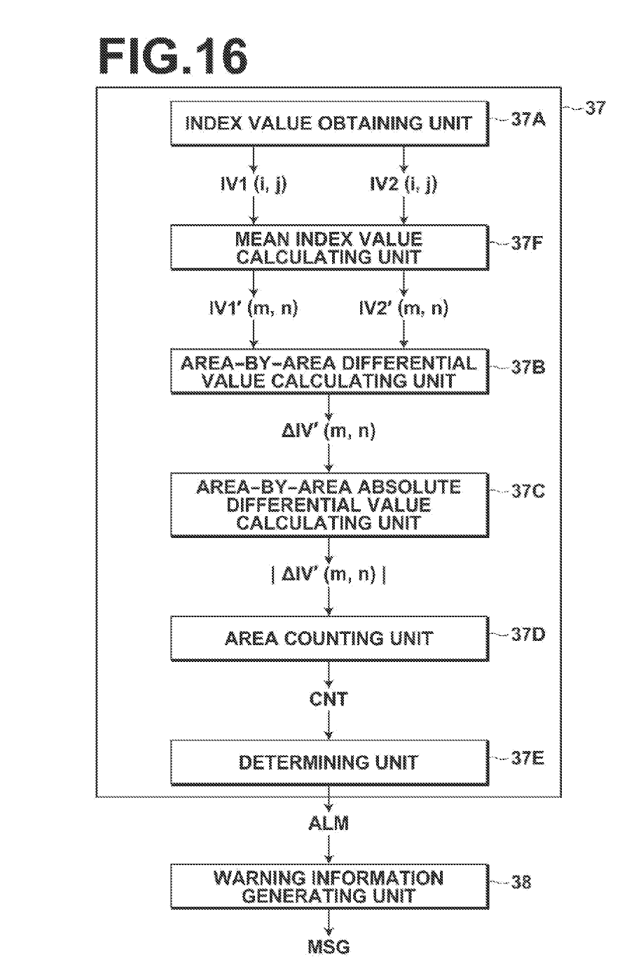

FIG. 16 is a block diagram schematically illustrating the configuration of the obstacle determining unit 37 and the warning information generating unit 38 according to a second embodiment of the invention. As shown in the drawing, the second embodiment of the invention includes a mean index value calculating unit 37F in addition to the configuration of the first embodiment.

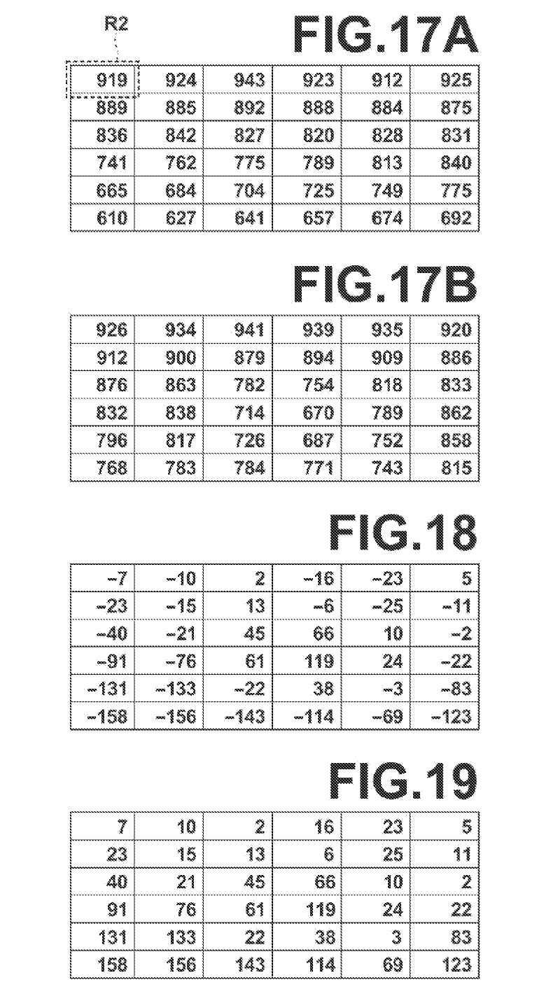

With respect the index values IV1(i,j), IV2 (i,j) of the individual areas obtained by the index value obtaining unit 37A, the mean index value calculating unit 37F calculates a mean value IV1′ (m, n) and a mean value IV2′ (m,n) of the photometric values for each set of four neighboring areas, where “m, n” means that the number of areas (the number of rows and the number of columns) at the time of output is different from the number of areas at the time of input, since the number is reduced by the calculation. FIGS. 17A and 17B show examples where, with respect to the photometric values of the 7×7 areas shown in FIGS. 12A and 12B, a mean value of the photometric values of each set of four neighboring areas (such as four areas enclosed in R1 shown. in FIG. 12A) is calculated, and mean photometric values of 6×6 areas are obtained (the mean photometric value of the values of the four areas enclosed in R1 is the value of the area enclosed in R2 shown in FIG. 17A). It should be noted that the number of areas included in each set at the time of input for calculating the mean value is not limited to four. In the following description, each area at the time of output is referred to as “combined area”.

The following operations of the processing units in the second embodiment are the same as those in the first embodiment, except that the areas are replaced with the combined areas.

Namely, in this embodiment, the area-by-area differential value calculating unit 37B calculates a differential value ΔIV′ (m, n) between the mean photometric values of each set of combined areas at mutually corresponding positions in the imaging ranges. FIG. 18 shows an example of the calculated differential values between the mean photometric values of mutually corresponding combined areas shown in FIGS. 17A and 17B.

The area-by-area absolute differential value calculating unit 370 calculates an absolute value |ΔIV′ (m,n)| of each differential value ΔIV′ (m,n) between the photometric values. FIG. 19 shows an example of the calculated absolute values of the differential values between the mean photometric values shown in FIG. 18.

The area counting unit 37D counts the number CNT of combined areas having absolute values |ΔIV′ (m,n)| of the differential values between the mean photometric values greater than a first threshold. In the example shown in FIG. 19, assuming that the threshold is 100, 8 areas among the 36 areas have absolute values |ΔIV (i,j)| greater than 100. Since the number of areas in the imaging range when the area counting unit 37D counts the number CNT is different from that of the first embodiment, the first threshold may have a different value from that of the first embodiment.

If the count CNT is greater than a second threshold, the determining unit 37E outputs the signal ALM that requests to output the warning message. Similarly to the first threshold, the second threshold may also have a different value from that of the first embodiment.

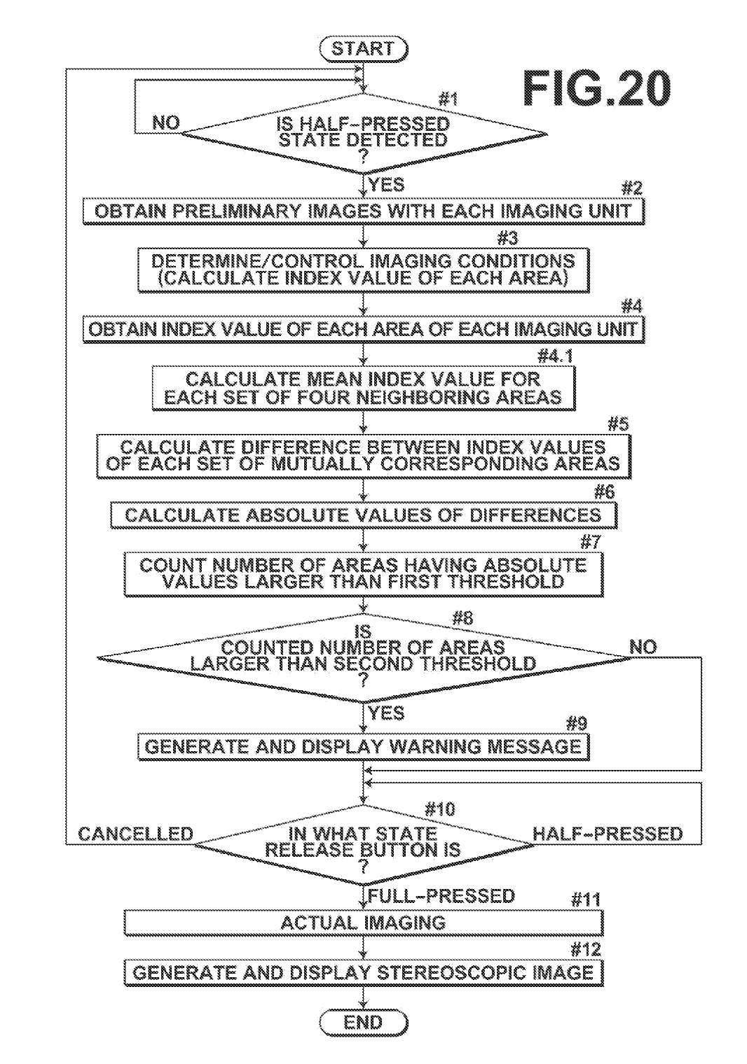

FIG. 20 is a flow chart illustrating the flow of a process carried out in the second embodiment of the invention. As shown in the drawing, after the index value obtaining unit 37A obtains the photometric values IV1 (1,j), IV2 (i,j) of the individual areas in step #4, the mean index value calculating unit 37F calculates the mean values IV1′ (m,n) and IV2′ (m,n) of the photometric values of each set of four neighboring areas, with respect to the index values IV1 (i,j), IV2 (i,j) of the individual areas (#4.1). The flow of the following operations is the same as that of the first embodiment, except that the areas are replaced with the combined areas.

As described above, in the second embodiment of the invention, the mean index value calculating unit 37F combines the areas divided at the time of photometry, and calculates the mean photometric value of each combined area. Therefore, an error due to a parallax between the imaging units is diffused by combining the areas, thereby reducing erroneous determinations.

It should be noted that, in this embodiment, the index values (photometric values) of the combined areas are not limited to mean values of the index values of the areas before combined, and may be any other representative value, such as a median value.

In a third embodiment of the invention, among the areas IV1 (i,j), IV2 (i,j) at the time of photometry in the first embodiment, areas around the center are not counted.

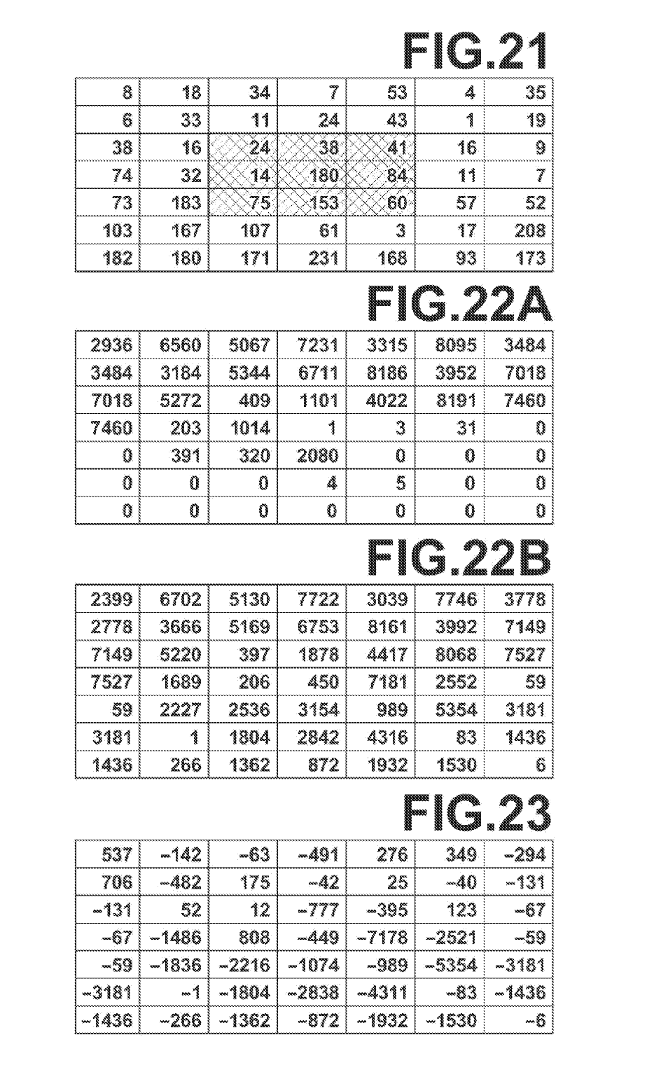

Specifically, in step #7 of the flowchart shown in FIG. 15, the area counting unit 37D counts the number CNT of areas having absolute values |ΔIV (i,j)| of the differential values between the photometric values of mutually corresponding areas greater than a first threshold, except the areas around the center. FIG. 21 shows an example where, among the 7×7 areas shown in FIG. 14, 3×3 areas around the center are not counted. In this case, assuming that the threshold is 100, 11 areas among marginal 40 areas have absolute values |ΔIV (i,j)| greater than 100. Then, the determining unit 37E compares this value (11) with a second threshold to determine whether or not there is an obstacle.

Alternatively, the index value obtaining unit 37A may not obtain the photometric values for the 3×3 areas around the center, or the area-by-area differential value calculating unit 37B or the area-by-area absolute differential value calculating unit 37C may not perform the calculation for the 3×3 areas around the center and may set a value which is not counted by the area counting unit 37D at the 3×3 areas around the center.

It should be noted that the number of areas around the center is not limited to 3×3.

The third embodiment of the invention, as described above, uses a fact that an obstacle always enters the imaging range from the marginal areas thereof. By not counting the central areas, which are less likely to contain an obstacle, of each imaging range when the photometric values are obtained and the determination as to whether or not there is an obstacle is performed, the determination can be achieved with higher accuracy.

In a fourth embodiment of the invention, the AF evaluation values are used as the index values in place of the photometric values used in the first embodiment. Namely, operations in the fourth embodiment are the same as those in the first embodiment, except that, in step #4 of the flow chart shown in FIG. 15, the index value obtaining unit 37A in the block diagram shown in FIG. 11 obtains the AF evaluation values, which are obtained by the AF processing unit 24, of the individual areas in the imaging ranges of the imaging units 21A and 21B.

FIG. 22A shows one example of the AF evaluation values of the individual areas in the imaging range of the imaging optical system of the imaging unit 21A in a case where an obstacle is contained at the lower part thereof, and FIG. 22B shows one example of the AF evaluation values of the individual areas in the imaging range where no obstacle is contained. In this example, the imaging range of each imaging unit 21A, 21B is divided into 7×7 areas, and the AF evaluation value of each area is calculated in a state where the focal point is at a position farther from the camera than the obstacle. Therefore, as shown in FIG. 22A, areas containing the obstacle have low AF evaluation values and low contrast.

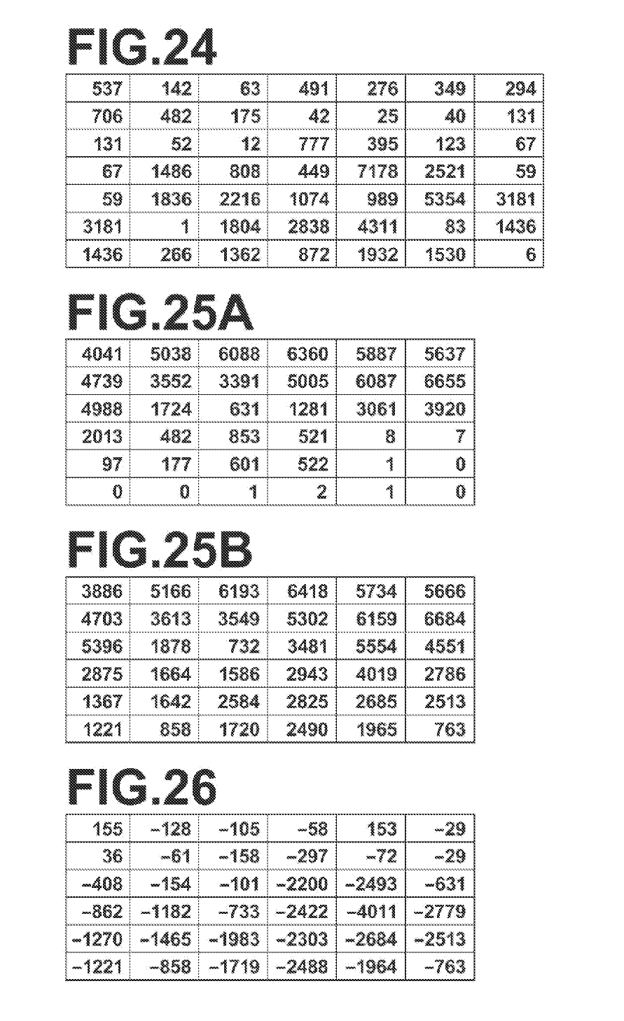

FIG. 23 shows an example of calculated differential values ΔIV (i,j) between mutually corresponding areas with assuming that each AF evaluation value shown in FIG. 22A is IV1 (i,j) and each AF evaluation value shown in FIG. 22B is IV2 (i,j). FIG. 24 shows an example of calculated absolute values |ΔIV (i,j)| of the differential values ΔIV (i,j). As shown in the drawings, in this example, when one of the imaging optical systems of the imaging units is covered by an obstacle, areas in the imaging range covered by the obstacle have large absolute values |ΔIV (i,j)|. Therefore, the number CNT of areas having absolute values |ΔIV (i,j)| greater than a predetermined first threshold is counted, and whether or not the count CNT is greater than a predetermined second threshold is determined, thereby determining the areas covered by the obstacle. It should be noted that, since the numerical significance of the index value is different from that in the first embodiment, the value of the first threshold is different from that in the first embodiment. The second threshold may be the same as or different from that in the first embodiment.

As described above, in the fourth embodiment of the invention, the AF evaluation values are used as the index values for the determination as to whether or not there is an obstacle. Therefore, even in cases where an obstacle and the background thereof in the imaging range have the same level of brightness or the same color, a reliable determination that an obstacle is contained can be made based on a difference of texture between the obstacle and the background in the imaging range.

Although the determination as to whether or not there is an obstacle by the obstacle determining unit 37 is achieved using the AF evaluation values obtained by the AF processing unit 24 in the above-described embodiment, there may be cases where it is impossible to obtain the AF evaluation value for each area in the imaging range, such as when a different focusing system is used. In such cases, each image G1, G2 obtained by each imaging unit 21A, 21B may be divided into a plurality of areas, in the same manner as described above, and an output value from a high-pass filter representing an amount of a high frequency component may be calculated for each area. In this manner, the same effect as that described above can be provided, except for an additional load for high-pass filtering.

In a fifth embodiment of the invention, the AF evaluation values are used as the index values in place of the photometric values used in the second embodiment, and the same effect as that in the second embodiment is provided. The configuration of the obstacle determining unit 37 is the same as that shown in the block diagram of FIG. 16, except for the difference of the index values, and the flow of the process is the same as that shown in the flow chart of FIG. 20.

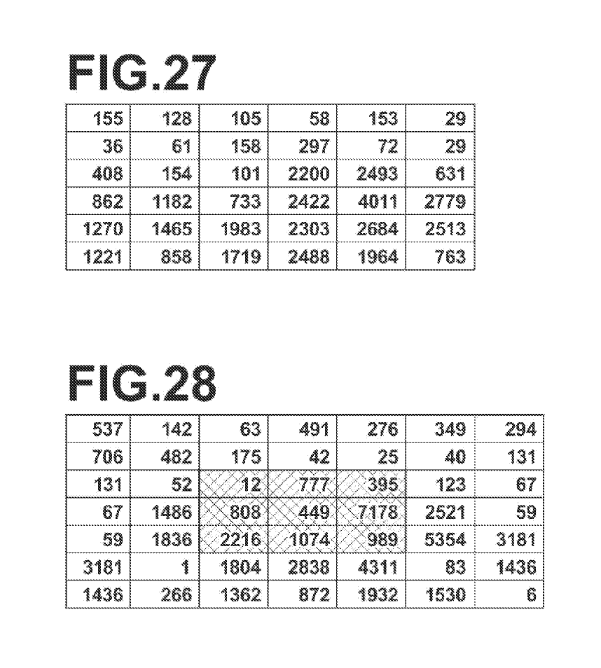

FIGS. 25A and 25B show examples where, with respect to the AF evaluation values of the 7×7 areas shown in FIGS. 22A and 22B, a mean value of the AF evaluation value of each set of four neighboring areas is calculated to provide mean AF evaluation values of 6×6 areas. FIG. 26 shows an example of calculated differential values between the mean AF evaluation values of mutually corresponding combined areas, and FIG. 27 shows an example of calculated absolute values of the differential values shown in FIG. 26.

In a sixth embodiment of the invention, the AF evaluation values are used as the index values in place of the photometric values used in the third embodiment, and the same effect as that in the third embodiment is provided.

FIG. 28 shows an example where 3×3 areas around the center among the 7×7 areas shown in FIG. 24 are not counted.

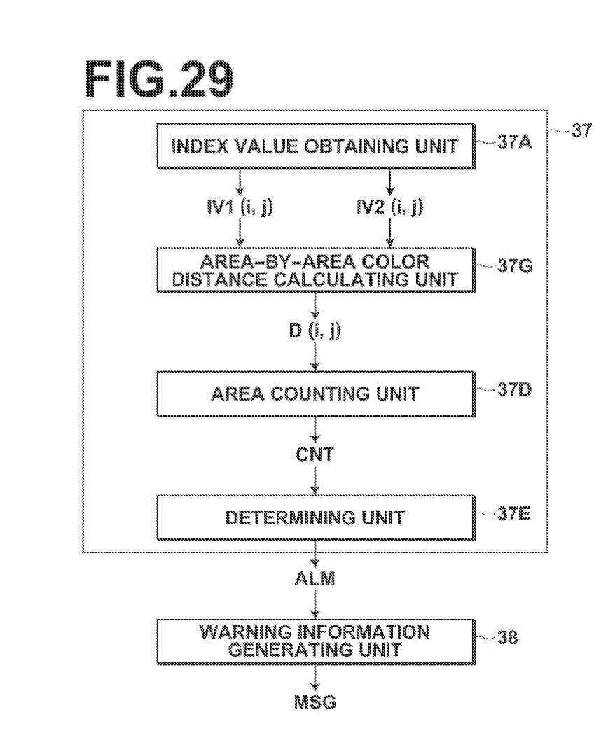

In a seventh embodiment of the invention, AWB color information values are used as the index values in place of the photometric values used in the first embodiment. When the color information values are used as the index values, it is not effective to simply calculate a difference between mutually corresponding areas, such as in the cases of the photometric values and the AF evaluation values. Therefore, a distance between the color information values of mutually corresponding areas is used. FIG. 29 is a block diagram schematically illustrating the configuration of the obstacle determining unit 37 and the warning information generating unit 38 according to this embodiment. As shown in the drawing, an area-by-area color distance calculating unit 37G is provided in place of the area-by-area differential value calculating unit 37B and the area-by-area absolute differential value calculating unit 37C in the first embodiment.

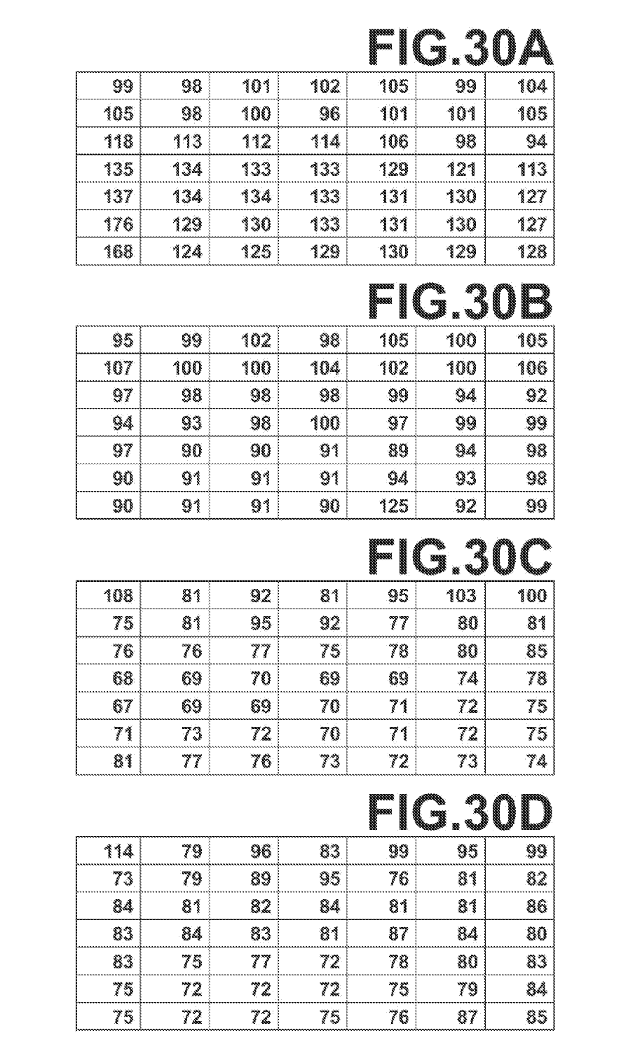

In this embodiment, the index value obtaining unit 37A obtains the color information values, which are obtained by the AWB processing unit 26, of the individual areas in the imaging ranges of the imaging units 21A and 21B. FIGS. 30A and 30C show examples of the color information values of the individual areas in the imaging range of the imaging optical system of the imaging unit 21A in a case where an obstacle is contained in the lower part thereof, and FIGS. 30B and 30D show examples of the color information values of the individual areas in the imaging range where no obstacle is contained. In the examples shown in FIGS. 30A and 30B, R/G is used as the color information value, and in the examples shown in FIGS. 300 and 30D, B/G is used as the color information value (where R, G and B refer to signal values of the red signal, the green signal and the blue signal in the RGB color space, respectively, and represent a mean signal value of each area) . In a case where an obstacle is present at a position close to the imaging optical system, the color information value of the obstacle is close to a color information value representing black. Therefore, when one of the imaging ranges of the imaging units 21A and 21B contains the obstacle, the areas of the imaging ranges have a large distance between the color information values thereof. It should be noted that the method for calculating the color information value is not limited to the above-described method. The color space is not limited to the RGB color space, and any other color space, such as Lab, may be used.

The area-by-area color distance calculating unit 37G calculates distances between color information values of areas at mutually corresponding positions in the imaging ranges. Specifically, in a case where each color information value is formed by two elements, the distance between the color information values is calculated, for example, as a distance between two points in a plot of values of the elements in the individual areas in a coordinate plane, where the first element and the second element are two perpendicular axes of coordinates. For example, assuming that values of the elements of the color information value of an area at the i-th row and the j-th column in the imaging range of the imaging unit 21A are RG1 and BG1, and values of the elements of the color information value of an area at the i-th row and the j-th column in the imaging range of the imaging unit 21B are RG2 and BG2, a distance D between the color information values of the mutually corresponding areas is calculated according to the equation below:

D=\sqrt{(RG1−RG2)+(BG1−BG2)²}

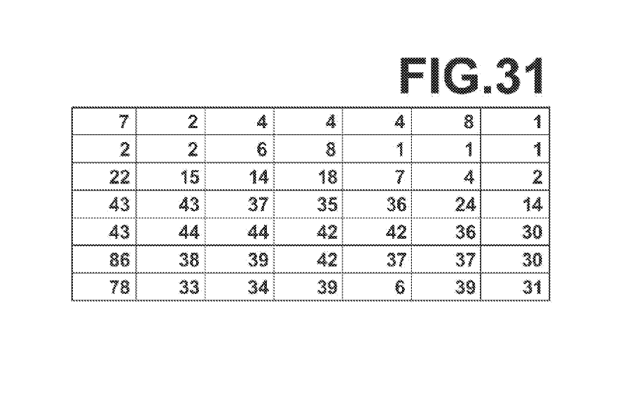

FIG. 31 shows an example of the distances between the color information values of the mutually corresponding areas calculated based on the color information values shown in FIGS. 30A to 30D.

The area counting unit 37D compares the values of the distances D between the color information values with a predetermined first threshold and counts the number CNT of areas having values of the distances D greater than the first threshold. For example, in the examples shown in FIG. 31, assuming that the threshold is 30, 25 areas among the 49 areas have values of the distances D greater than 30.

Similarly to the first embodiment, if the count CNT obtained by the area counting unit 37D is greater than a second threshold, the determining unit 37E outputs the signal ALM that requests to output the warning message.

It should be noted that, since the numerical significance of the index value is different from that in the first embodiment, the value of the first threshold is different from that in the in the first embodiment. The second threshold may be the same as or different from that in the first embodiment.

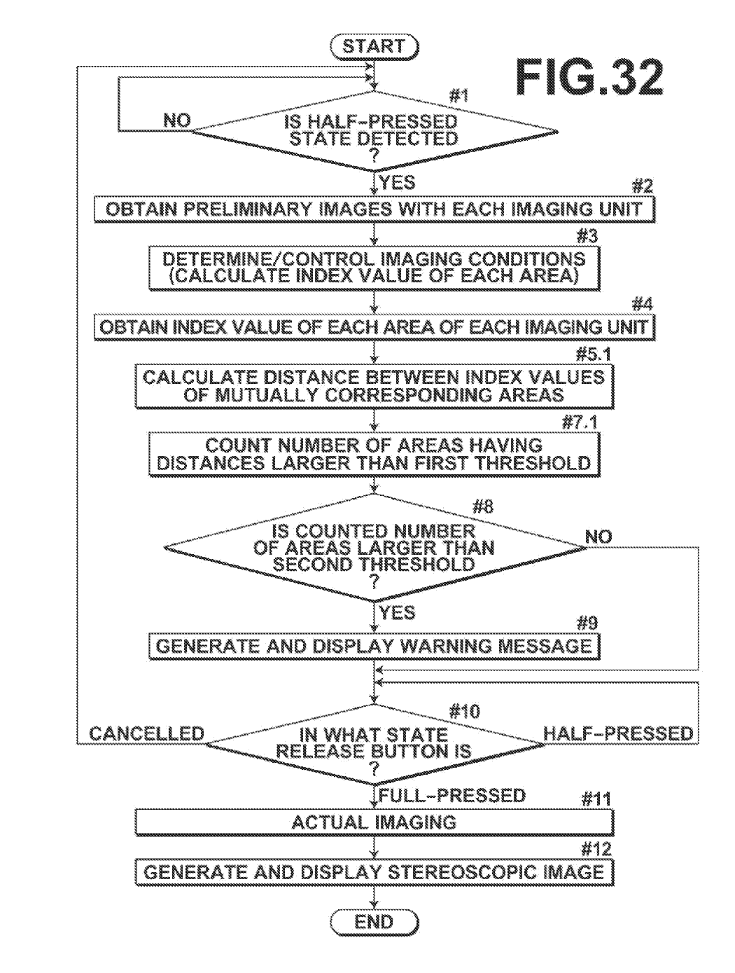

FIG. 32 is a flow chart illustrating the flow of a process carried out in the seventh embodiment of the invention. First, similarly to the first embodiment, when the half-pressed state of the release button 2 is detected (#1: YES), the preliminary images G1 and G2 for determining imaging conditions are obtained by the imaging units 21A and 21B, respectively (#2). Then, the AF processing unit 24, the AE processing unit 25 and the AWB processing unit 26 perform operations to determine various imaging conditions, and the components of the imaging units 21A and 21B are controlled according to the determined imaging conditions (#3). At this time, the AWB processing unit 26 obtains the color information values IV1 (i,j), IV2 (i,j) of the individual areas in the imaging ranges of the imaging units 21A and 21B.

Then, at the obstacle determining unit 37, after the index value obtaining unit 37A obtains the color information values IV1 (i,j), IV2 (i,j) of the individual areas (#4), the area-by-area color distance calculating unit 37G calculates the distance D (i,j) between the color information values of each set of areas at mutually corresponding positions in the imaging ranges (#5.1). Then, the area counting unit 37D counts the number CNT of areas having values of the distances D (i,j) between the color information values greater than the first threshold (#7.1). The flow of the following operations is the same as that of step #8 and the following steps in the first embodiment.

As described above, in the seventh embodiment of the invention, the color information values are used as the index values for the determination as to whether or not there is an obstacle. Therefore, even when an obstacle and the background thereof in the imaging range have the same level of brightness or similar textures, a reliable determination that an obstacle is contained can be made based on a difference of color between the obstacle and the background in the imaging range.

It should be noted that, although the determination as to whether or not there is an obstacle by the obstacle determining unit 37 is achieved using the color information values obtained by the AWB processing unit 26 in the above-described embodiment, there may be cases where it is impossible to obtain the color information value for each area in the imaging range, such as a case where a different automatic white balance control method is used. In such cases, each image Gl, G2 obtained by each imaging unit 21A, 21B may be divided into a plurality of areas, in the same manner as described above, and the color information value may be calculated for each area.

In this manner, the same effect as that described above can be provided, except for an additional load for calculating the color information values.

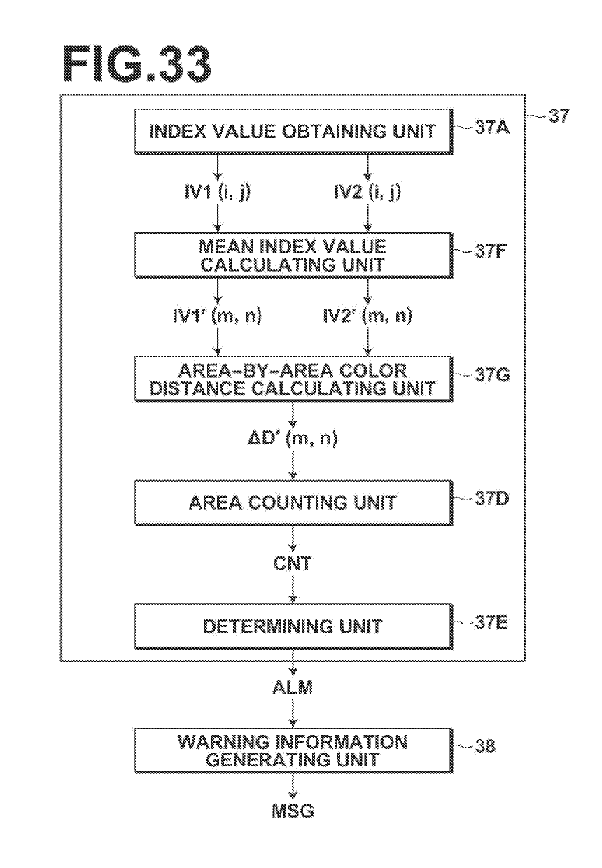

FIG. 33 is a block diagram schematically illustrating the configuration of the obstacle determining unit 37 and the warning information generating unit 38 according to an eighth embodiment of the invention. As shown in the drawing, the eighth embodiment of the invention includes a mean index value calculating unit 37F in addition to the configuration of the seventh embodiment.

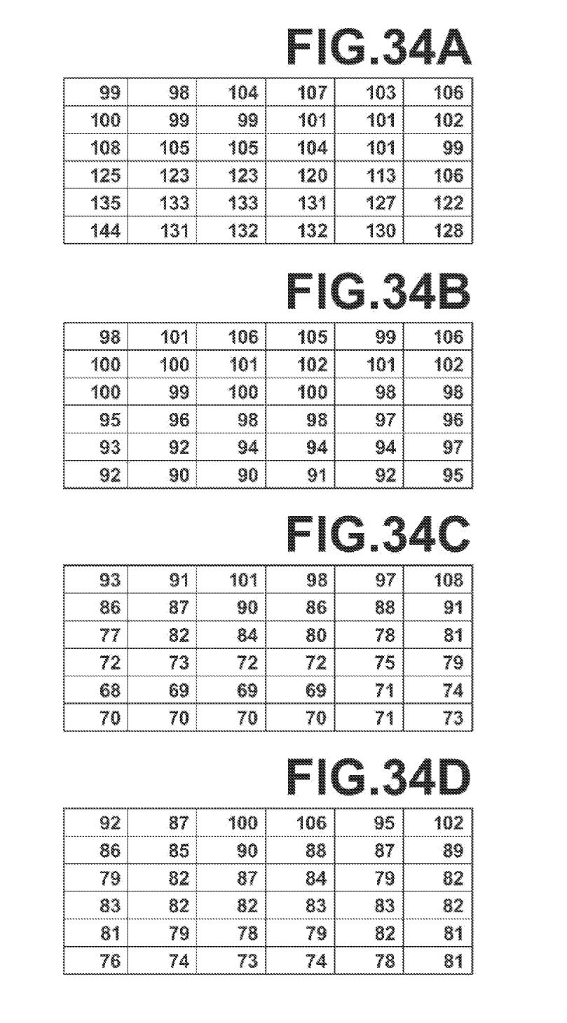

The mean index value calculating unit 37F calculates, with respect to the elements of the color information values IV1 (i,j), IV2 (i,j) of the individual areas obtained by the index value obtaining unit 37A, a mean value IV1′ (m, n) and a mean value IV2′ (m,n) of the values of the elements of the color information values IV1 (i,j) and IV2 (i,j) for each set of four neighboring areas. The “m,n” here has the same meaning as that in the second embodiment. FIGS. 34A to 34D show examples where mean color information elements of 6×6 areas (combined areas)are obtained by calculating the mean value of the elements of the color information values of each set of four neighboring areas of the 7×7 areas shown in FIGS. 30A to 30D. It should be noted that the number of areas included in each set at the time of input for calculating the mean value is not limited to four.

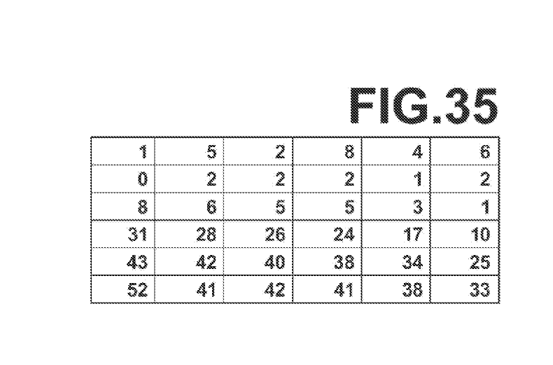

The following operations of the processing units in the eighth embodiment are the same as those in the seventh embodiment, except that the areas are replaced with the combined areas. FIG. 35 shows an example of calculated distances between the color information values of mutually corresponding combined areas shown in FIGS. 34A to 34D.

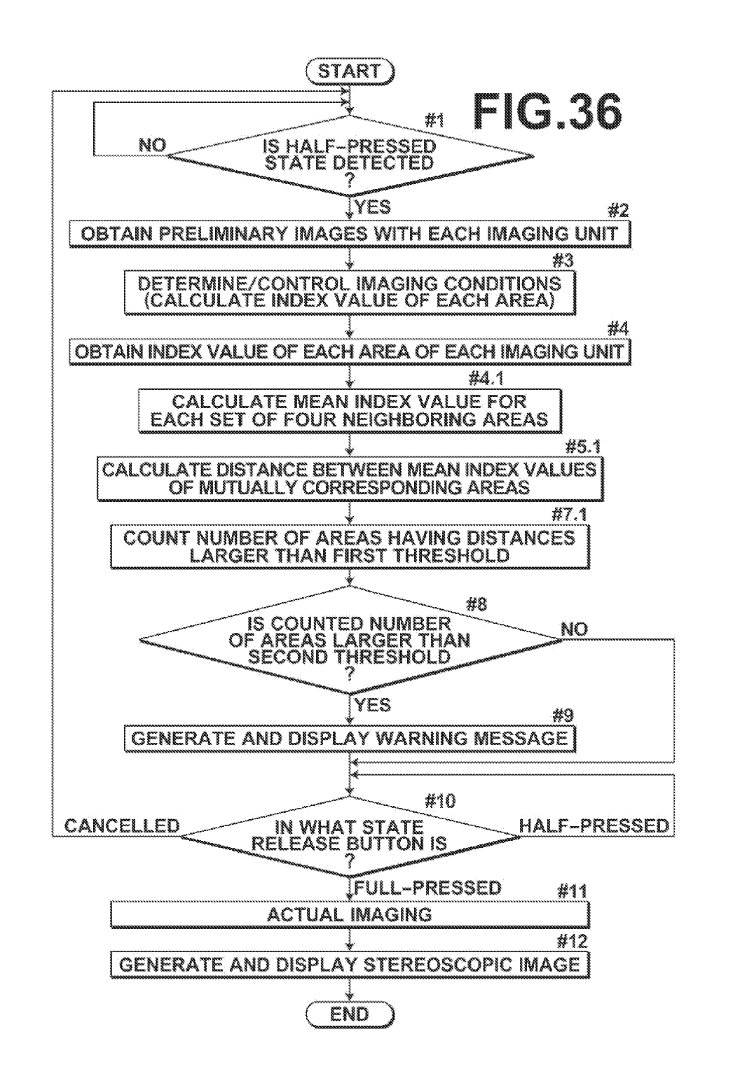

As shown in the flow chart of FIG. 36, the flow of the operations in this embodiment is a combination of the processes of the second and seventh embodiments. Namely, in this embodiment, similarly to the second embodiment, after the index value obtaining unit 37A obtains the color information values IV1 (i,j), IV2 (i,j) of the individual areas in step #4, the mean index value calculating unit 37F calculates, with respect to the index values IV1 (i,j), IV2 (i,j) of the individual areas, the mean value IV1′ (m,n), IV2′ (m,n) of the color information values of each set of four neighboring areas (#4.1). The flow of the other operations is the same as that in the seventh embodiment, except that the areas are replaced with the combined areas.

In this manner, the same effect as that in the second and fifth embodiments is provided in the eighth embodiment of the invention, where the color information values are used as the index values.

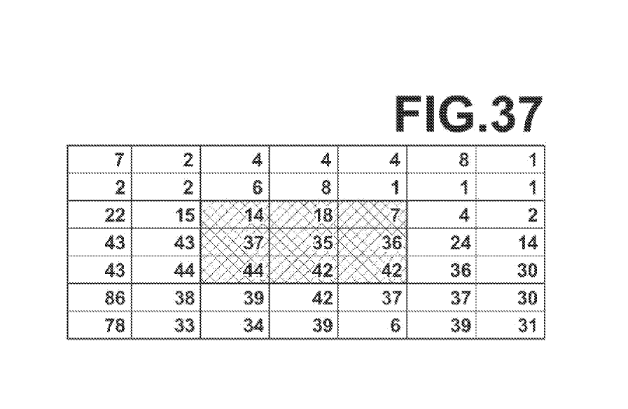

In a ninth embodiment of the invention, among the areas IV1 (i,j) and IV2 (1,j) divided at the time of automatic white balance control in the seventh embodiment, areas around the center are not counted, and the same effect as that in the third embodiment is provided. FIG. 37 shows an example where, among the 7×7 areas divided at the time of automatic white balance control, 3×3 areas around the center are not counted by the area counting unit 37D.

The determination as to whether or not there is an obstacle may be performed using two or more different types of index values described as examples in the above-described embodiments. specifically, the determination as to whether or not there is an obstacle may be performed based on the photometric values according to any one of the first to third embodiments, then, the determination may be performed based on the AF evaluation values according to any one of the fourth to sixth embodiments, and then the determination may be performed based on the color information values according to any one of the seventh to ninth embodiments. Then, if it is determined that an obstacle is contained in at least one of the determination processes, it may be determined that at least one of the imaging units is covered by an obstacle.

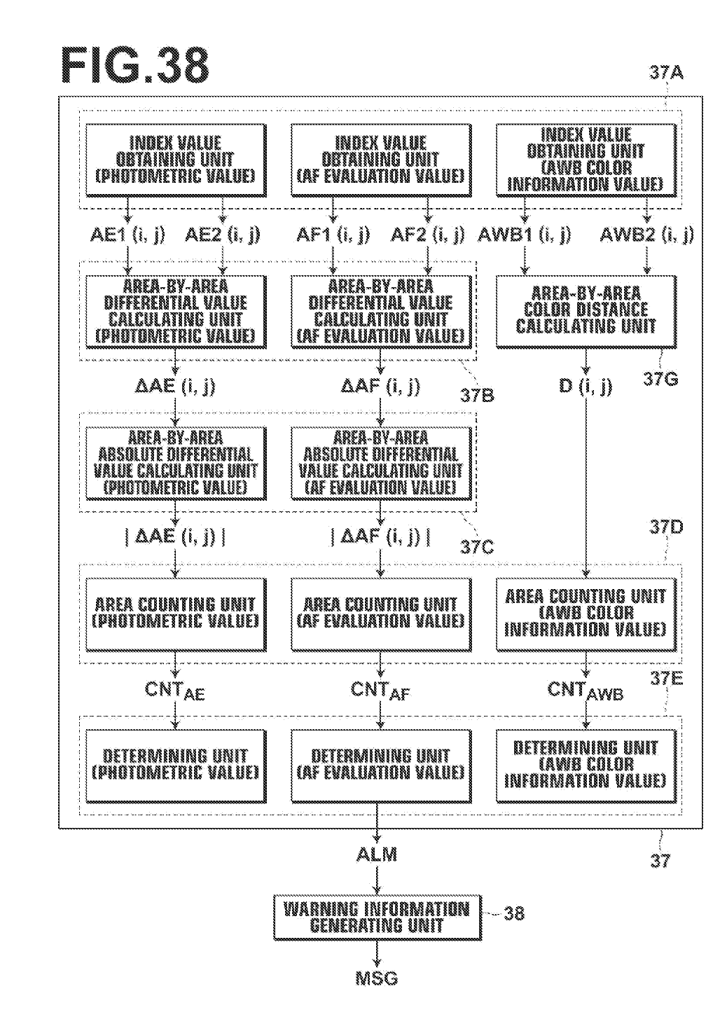

FIG. 38 is a block diagram schematically illustrating the configuration of the obstacle determining unit 37 and the warning information generating unit 38 according to a tenth embodiment of the invention. As shown in the drawing, the configuration of the obstacle determining unit 37 of this embodiment is a combination of the configurations of the first, fourth and seventh embodiments. Namely, the obstacle determining unit 37 of this embodiment is formed by the index value obtaining units 37A for the photometric value, the AF evaluation value and the AWB color information value, the area-by-area differential value calculating units 37B for the photometric value and the AF evaluation value, the area-by-area absolute differential value calculating units 37C for the photometric value and the AF evaluation value, the area-by-area color distance calculating unit 37G, the area counting units 37D for the photometric value, the AF evaluation value and the AWB color information value, and the determining units 37E for the photometric value, the AF evaluation value and the AWB color information value. The specific contents of these processing units are the same as those in the first, fourth and seventh embodiments.

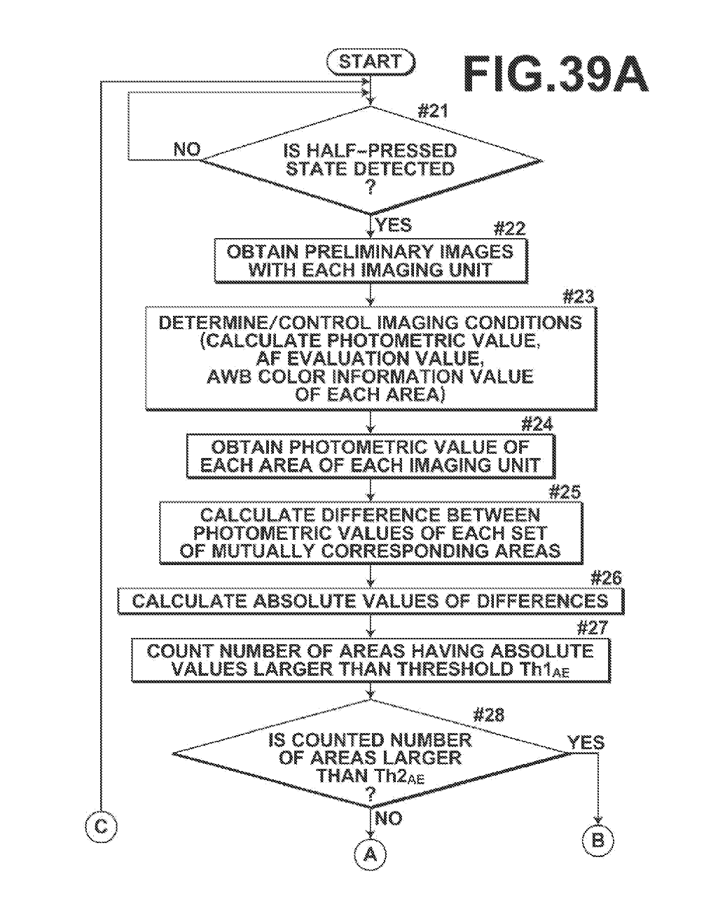

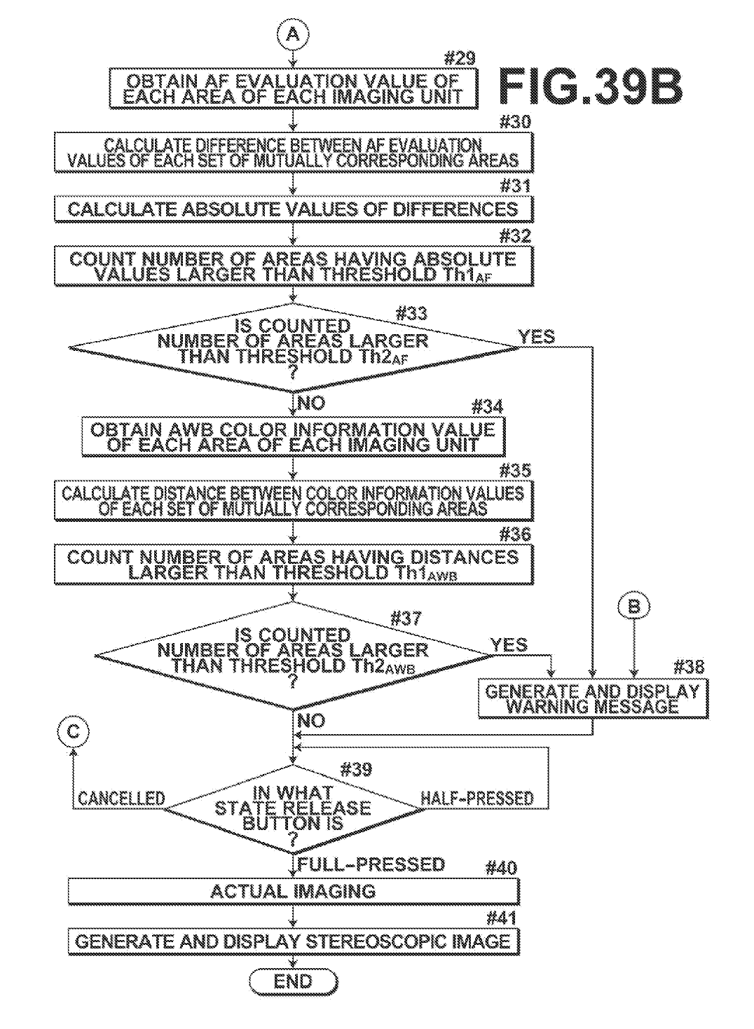

FIGS. 39A and 39B show a flow chart illustrating the flow of a process carried out in the tenth embodiment of the invention. As shown in the drawings, similarly to the individual embodiments, when the half-pressed state of the release button 2 is detected (#21: YES), the preliminary images G1 and G2 for determining imaging conditions are obtained by the imaging units 21A and 21B, respectively (#22). Then, the AF processing unit 24, the AE processing unit 25 and the AWB processing unit 26 perform operations to determine various imaging conditions, and the components of the imaging units 21A and 21B are controlled according to the determined imaging conditions (#23).

Operations insteps #24 to #28 are the same as those in steps #4 to #8 in the first embodiment, where the obstacle determination process is performed based on the photometric values. Operations in steps #29 to #33 are the same as those in steps #4 to #8 in the fourth embodiment, where the obstacle determination process is performed based on the AF evaluation values. Operations in steps #34 to #37 are the same as those in steps #4 to #8 in the seventh embodiment, where the obstacle determination process is performed based on the AWB color information values.

Then, if it is determined that an obstacle is contained in any of the determination processes (#28, #33, #37: YES), the determining unit 37E corresponding to the type of the index values used outputs the signal ALM that requests to output the warning message, and the warning information generating unit 38 generates the warning message MSG in response to the signal ALM (#38), similarly to the above-described embodiments. The following steps #39 to #41 are the same as steps #10 to #12 in the above-described embodiments.

As described above, according to the tenth embodiment of the invention, if it is determined that an obstacle is contained in at least one of the determination processes using the different types of index values, it is determined that at least one of the imaging units is covered by an obstacle. This allows compensating for disadvantages based on characteristics of one type of index value with advantages of other types of index values, thereby achieving the determination as to whether or not an obstacle is contained with higher and more stable accuracy under various conditions of the obstacle and the background in the imaging range. For example, in a case where an obstacle and the background thereof in the imaging range have the same level of brightness, for which it is difficult to correctly determine that an obstacle is contained based only on the photometric values, the determination based on the AF evaluation values or the color information values may also be performed, thereby achieving a correct determination.

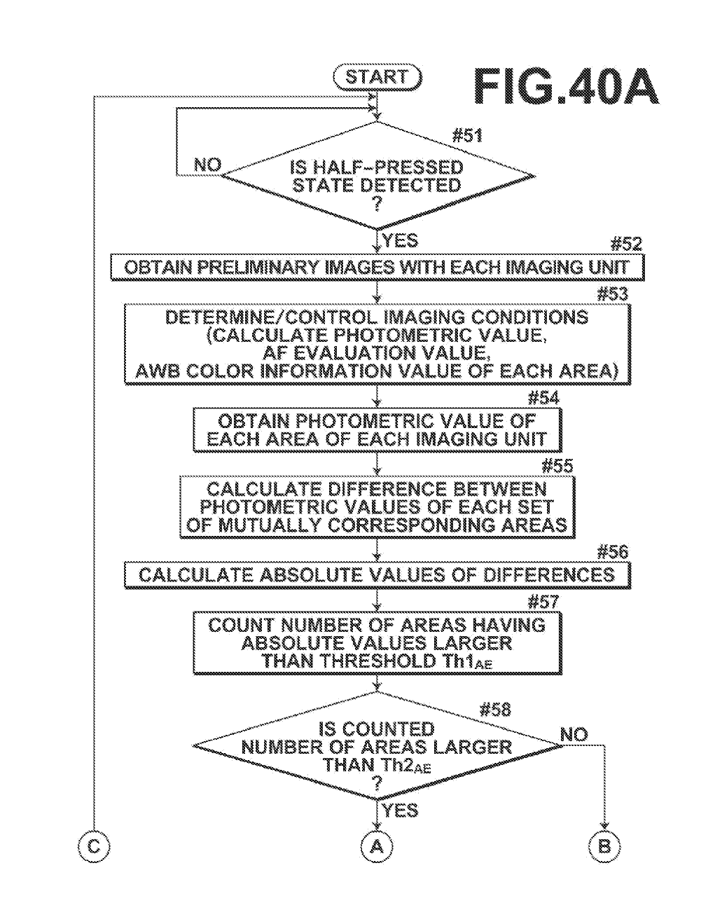

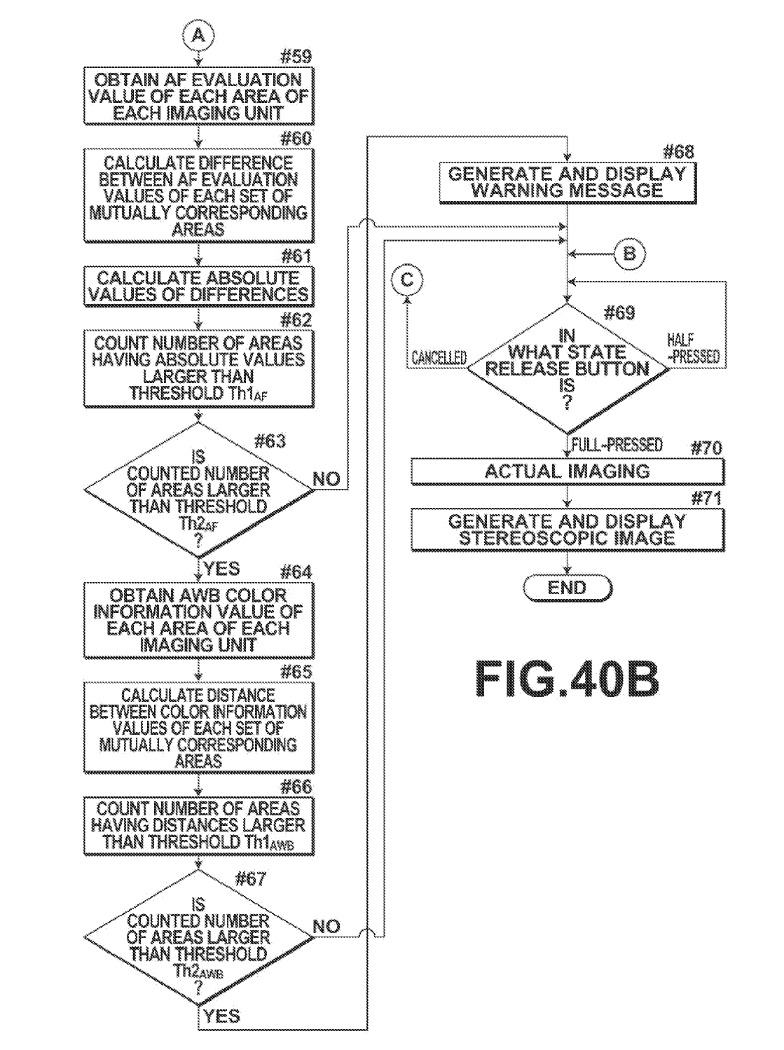

On the other hand, in an eleventh embodiment of the invention, if it is determined that an obstacle is contained in all the determination processes using the different types of index values, it is determined that at least one of the imaging units is covered by an obstacle. The configuration of the obstacle determining unit 37 and the warning information generating unit 38 according to this embodiment is the same as that in the tenth embodiment. FIG. 40A and 40B show a flow chart illustrating the flow of a process carried out in the eleventh embodiment of the invention. As shown in the drawings, operations in steps #51 to #57 are the same as those in steps #21 to #27 in the tenth embodiment. In step #58, if the number of areas having absolute values of the photometric values greater than a threshold Th1 is smaller than or equal to a threshold Th2_{AE}, the determination processes based on other types of index values are skipped (#58: NO). In contrast, if the number of areas having absolute values of the photometric values greater than the threshold Th1_{AE} is greater than the threshold Th2_{AE}, that is, if it is determined that an obstacle is contained based on the photometric value, the determination process based on the AF evaluation value is performed in the same manner as in steps #29 to #32 in the tenth embodiment (#59 to #62) . Then, in step #63, if the number of areas having absolute values of the AF evaluation values greater than a threshold Th1_{AF} is smaller than or equal to a threshold Th2_{AF}, the determination process based on other type of index value is skipped (#63: NO). In contrast, if the number of areas having absolute values of the AF evaluation values greater than the threshold Th1_{AF} is greater than the threshold Th2_{AF}, that is, if it is determined that an obstacle is contained based on the AF evaluation value, the determination process based on the AWB color information value is performed in the same manner as in steps #34 to #36 in the tenth embodiment (#64 to #66). Then, in step #67, if the number of areas having color distances based on the AWB color information values greater than a threshold Th1_{AWB} is smaller than or equal to a threshold Th2_{AWB} the operation to generate and display the warning message in step #68 is skipped (#67: NO). In contrast, if the number of areas having color distances based on the AWB color information values greater than the threshold Th1_{AWB} is greater than the threshold Th2_{AWB}, that is, if it is determined that an obstacle is contained based on the AWB color information value (#67: YES), now, it is determined that an obstacle is contained based on all the photometric value, the AF evaluation value and the color information value. Therefore, the signal ALM that requests to output the warning message is outputted, and the warning information generating unit 38 generates the warning message MSG in response to the signal ALM, similarly to the above-described embodiments (#68). The following steps #69 to #71 are the same as steps #39 to #41 in the tenth embodiment.

As described above, according to the eleventh embodiment of the invention, the determination that an obstacle is contained is effective only when the same determination is made based on all the types of index values. In this manner, erroneous determination, where a determination that an obstacle is contained is made even when no obstacle is contained actually, is reduced.

As a modification of the eleventh embodiment, the determination that an obstacle is contained may be regarded effective only when the same determination is made based on two or more types of index values among the three types of index values. Specifically, for example, in steps #58, #63 and #67 shown in FIGS. 40A and 40B, a flag representing a result of the determination in each step may be set, and after step #67, if two or more flags have a value indicating that an obstacle is contained, the operation to generate and display the warning message in step #68 may be performed.

Alternatively, in the above-described tenth and eleventh embodiments, only two types of index values among the three types of index values may be used.

The above-described embodiments are presented solely by way of example, and all the above description should not be construed to limit the technical scope of the invention. Further, variations and modifications made to the configuration of the stereoscopic imaging device, the flow of the processes, the modular configurations, the user interface and the specific contents of the processes in the above-described embodiments without departing from the spirit and scope of the invention are within the technical scope of the invention.

For example, although the above-described determination is performed when the release button is half-pressed in the above-described embodiments, the determination may be performed when the release button is fully-pressed, for example. Even in this case, the operator maybe notified, immediately after the actual imaging, of the fact that the taken picture is an unsuccessful picture containing an obstacle, and can retake another picture. In this manner, unsuccessful pictures can sufficiently be reduced.

Further, although the stereoscopic camera including two imaging units is described as an example in the above-described embodiments, the present invention is also applicable to a stereoscopic camera including three or more imaging units. Assuming that the number of imaging units is N, the determination as to whether or not at least one of the imaging optical systems is covered with an obstacle can be achieved by repeating the determination process or performing the determination processes in parallel for _{N}C₂ combinations of the imaging units.

Still further, in the above-described embodiments, the obstacle determining unit 37 may further include a parallax control unit, which may perform the operation by the index value obtaining unit 37A and the following operations on the imaging ranges subjected to parallax control. Specifically, the parallax control unit detects a main subject (such as a person's face) from the first and second images G1 and G2 using a known technique, finds an amount of parallax control (a difference between the positions of the main subject in the images) that provides a parallax of 0 between the images (see Japanese Unexamined Patent Publication Nos. 2010-278878 and 2010-288253, for example, for details), and transforms (for example, translates) a coordinate system of at least one of the imaging ranges by the amount of parallax control. This reduces an influence of the parallax of the subject in the images on the output value from the area-by-area differential value calculating unit 37B or the area-by-area color distance calculating unit 37G, thereby improving the accuracy of the obstacle determination performed by the determining unit 37E.

In a case where the stereoscopic camera has a macro (close-up) imaging mode, which provides imaging conditions suitable for capturing a subject at a position close to the camera, it is supposed that a subject close to the camera is to be captured when the macro imaging mode is set. In this case, the subject itself may be erroneously determined to be an obstacle. Therefore, prior to the above-described obstacle determination process, information of the imaging mode may be obtained, and if the set imaging mode is the macro imaging mode, the obstacle determination process, i.e., the operations to obtain the index values and/or to determine whether or not an obstacle is contained may not be performed. Alternatively, the obstacle determination process may be performed and the notification may not be presented even when it is determined that an obstacle is contained.

Alternatively, even when the macro imaging mode is not set, if a distance (subject distance) from the imaging units 21A and 21B to the subject is smaller than a predetermined threshold, the obstacle determination process may not be performed, or the obstacle determination process may be performed and the notification may not be presented even when it is determined that an obstacle is contained. To calculate the subject distance, the positions of the focusing lenses of the imaging units 21A and 21B and the AF evaluation value may be used, or triangulation may be used together with stereo matching between the first and second images G1 and G2.

In the above-described embodiments, when the first and second images G1 and G2, where one of the images contains an obstacle and the other of the images contains no obstacle, are stereoscopically displayed, it is difficult to recognize where the obstacle is present in the stereoscopically displayed image. Therefore, when it is determined by the obstacle determining unit 37 that an obstacle is contained, one of the first and second images G1 and G2 which contains no obstacle may be processed such that areas of the image containing no obstacle corresponding to areas containing the obstacle of the other image appear to contain the obstacle. Specifically, first, the areas containing the obstacle (obstacle areas) or the areas corresponding to the obstacle areas (obstacle-corresponding areas) in each image is identified using the index values. The obstacle areas are areas having absolute values of the differential values between the index values greater than the above-described predetermined threshold. Then, one of the first and second images G1 and G2 that contains the obstacle is identified. The identification of the image that actually contains the obstacle can be achieved by identifying one of the images that includes darker obstacle areas in the case where the index values are photometric values or luminance values, or by identifying one of the images that includes obstacle areas having lower contrast in the case where the index values are the AF evaluation values, or by identifying one of the images that includes obstacle areas having a color close to black in the case where the index values are the color information values. Then, the other of the first and second images G1 and G2 that actually contains no obstacle is processed to change pixel values of the obstacle-corresponding areas into pixel values of the obstacle areas of the image that actually contains the obstacle. In this manner, the obstacle-corresponding areas have the same darkness, contrast and color as those of the obstacle areas, that is, they shows a state where the obstacle is contained. By stereoscopically displaying the thus processed first and second images G1 and G2 in the form of a live-view image, or the like, visual recognition of the presence of the obstacle is facilitated. It should be noted that, when the pixel values are changed as described above, not all but only some of the darkness, contrast and color may be changed.

The obstacle determining unit 37 and the warning information generating unit 38 in the above-described embodiments may be incorporated into a stereoscopic display device, such as a digital photo frame, that generates a stereoscopic image GR from an image file containing a plurality of parallax images, such as the image file of the first image G1 and the second image G2 (see FIG. 5) in the above-described embodiments, inputted thereto to perform stereoscopic display, or a digital photo printer that prints an image for stereoscopic viewing. In this case, the photometric values, the AF evaluation values, the AWB color information values, or the like, of the individual areas in the above-described embodiments may be recorded as the accompanying information of the image file, so that the recorded information is used. Further, with respect to the above-described problem of the macro imaging mode, if an imaging device is controlled such that the obstacle determination process is not performed during the macro imaging mode, information indicating that it is determined not to perform the obstacle determination process may be recorded as the accompanying information of each captured image. In this case, a device provided with the obstacle determining unit 37 may determine whether or not the accompanying information includes the information indicating that it is determined not to perform the obstacle determination process, and if the accompanying information includes the information indicating that it is determined not to perform the obstacle determination process, the obstacle determination process may not be performed. Alternatively, if the imaging mode is recorded as the accompanying information, the obstacle determination process may not be performed if the imaging mode is the macro imaging mode.

What is claimed is:

1. A stereoscopic imaging device comprising:
a plurality of imaging units for capturing a subject and outputting captured images, the imaging units including imaging optical systems positioned to allow stereoscopic display of the subject using the captured images outputted from the imaging units, wherein each imaging unit performs photometry at a plurality of points or areas in an imaging range thereof to determine an exposure for capturing the image using photometric values obtained by the photometry;
an index value obtaining unit for obtaining the photometric value as an index value for each of a plurality of subranges of the imaging range of each imaging unit;
an obstacle determining unit for comparing the index values of each set of the subranges at mutually corresponding positions in the imaging ranges of the different imaging units with each other, and if a difference between the index values in the imaging ranges of the different imaging units is large enough to satisfy a predetermined criterion, determining that the imaging range of at least one of the imaging units contains an obstacle that is close to the imaging optical system of the at least one of the imaging units;
a macro imaging mode setting unit for setting a macro imaging mode that provides imaging conditions suitable for capturing the subject at a position close to the stereoscopic imaging device; and
a unit for exerting a control such that the determination is not performed when the macro imaging mode is set.

2. The stereoscopic imaging device as claimed in claim 1, wherein the imaging units outputs images captured by actual imaging and outputs images captured by preliminary imaging that is performed prior to the actual imaging for determining imaging conditions for the actual imaging, and the index value obtaining unit obtains the index values in response to the preliminary imaging.

3. The stereoscopic imaging device as claimed in claim 1, wherein each imaging unit performs focus control of the imaging optical system of the imaging unit based on AF evaluation values at the plurality of points or areas in the imaging range thereof, and
the index value obtaining unit obtains the AF evaluation value as an additional index value for each of the subranges of the imaging range of each imaging unit.

4. The stereoscopic imaging device as claimed in claim 1, wherein the index value obtaining unit extracts an amount of a high spatial frequency component that is high enough to satisfy predetermined criterion from each of the captured images, and obtains the amount of each of the subranges of the high frequency component as an additional index value.

5. The stereoscopic imaging device as claimed in claim 1, wherein each imaging unit performs automatic white balance control of the imaging unit based on color information values at the plurality of points or areas in the imaging range thereof, and
the index value obtaining unit obtains the color information value as an additional index value for each of the subranges of the imaging range of each imaging unit.

6. The stereoscopic imaging device as claimed in claim 1, wherein the index value obtaining unit calculates a color information value for each of the subranges from each of the captured images, and obtains the color information value as an additional index value.

7. The stereoscopic imaging device as claimed in claim 1, wherein each of the subranges includes two or more of the plurality of points or areas therein, and
the index value obtaining unit calculates the index value for each subrange based on the index values at the points or areas in the subrange.

8. The stereoscopic imaging device as claimed in claim 1, wherein a central area of each imaging range is not processed by the index value obtaining unit and/or the obstacle determining unit.

9. The stereoscopic imaging device as claimed in claim 3, wherein the obstacle determining unit performs the comparison based on two or more types of the index values, and if a difference based on at least one of the index values is large enough to satisfy a predetermined criterion, determines that the imaging range of at least one of the imaging units contains an obstacle that is close to the imaging optical system of the at least one of the imaging units.

10. The stereoscopic imaging device as claimed in claim 4, wherein the obstacle determining unit performs the comparison based on two or more types of the index values, and if a difference based on at least one of the index values is large enough to satisfy a predetermined criterion, determines that the imaging range of at least one of the imaging units contains an obstacle that is close to the imaging optical system of the at least one of the imaging units.

11. The stereoscopic imaging device as claimed in claim 5, wherein the obstacle determining unit performs the comparison based on two or more types of the index values, and if a difference based on at least one of the index values is large enough to satisfy a predetermined criterion, determines that the imaging range of at least one of the imaging units contains an obstacle that is close to the imaging optical system of the at least one of the imaging units.

12. The stereoscopic imaging device as claimed in claim 6, wherein the obstacle determining unit performs the comparison based on two or more types of the index values, and if a difference based on at least one of the index values is large enough to satisfy a predetermined criterion, determines that the imaging range of at least one of the imaging units contains an obstacle that is close to the imaging optical system of the at least one of the imaging units.

13. The stereoscopic imaging device as claimed in claim 1 further comprising a notifying unit, wherein, if it is determined that an obstacle is contained in the imaging range, the notifying unit notifies to that effect.

14. The stereoscopic imaging device as claimed in claim 1, wherein the obstacle determining unit controls a correspondence between positions in the imaging ranges to provide a parallax of substantially 0 of a main subject in the captured images outputted from the imaging units, and then, compares the index values of each set of the subranges at mutually corresponding positions in the imaging ranges of the different imaging units with each other.

15. The stereoscopic imaging device as claimed in claim 1 further comprising:
a unit for calculating a subject distance, the subject distance being a distance from the imaging unit to the subject; and
a unit for exerting a control such that the determination is not performed if the subject distance is smaller than a predetermined threshold.

16. The stereoscopic imaging device as claimed in claim 1 further comprising:
a unit for identifying any of the captured images containing the obstacle and identifying an area containing the obstacle in the identified captured image based on the index values if it is determined by the obstacle determining unit that the obstacle is contained; and
a unit for changing an area of the captured image not identified to contain the obstacle corresponding to the identified area of the identified captured image such that the area corresponding to the identified area has a same pixel value as that of the identified area.

17. An obstacle determination device comprising:
an index value obtaining unit for obtaining, from a plurality of captured images for stereoscopically displaying a main subject obtained by capturing the main subject from different positions using imaging units, or from accompanying information of the captured images, photometric values at a plurality of points or areas in each imaging range for capturing each captured image as index values for each of subranges of the imaging range, the photometric values being obtained by photometry for determining an exposure for capturing the image;
a determining unit for comparing the index values of each set of the subranges at mutually corresponding positions in the imaging ranges of the different plurality of captured images with each other, and if a difference between the index values in the imaging ranges of the different plurality of captured images is large enough to satisfy a predetermined criterion, determining that the imaging range of at least one of the captured images contains an obstacle that is close to an imaging optical system of the imaging unit;
a macro imaging mode determining unit for determining, based on the accompanying information of the captured images, whether or not the captured images are captured using a macro imaging mode that provides imaging conditions suitable for capturing a subject at a position close to the stereoscopic imaging device; and
a unit for exerting a control such that, if it is determined that the captured images are captured using the macro imaging mode, the determination by the determining means is not performed.

18. An obstacle determining method for use with a stereoscopic imaging device including a plurality of imaging units for capturing a subject and outputting captured images, the imaging units including imaging optical systems positioned to allow stereoscopic display of the subject using the captured images outputted from the imaging units, the method being used to determine whether or not an obstacle is contained in an imaging range of at least one of the imaging units,
wherein each imaging unit performs photometry at a plurality of points or areas in the imaging range thereof to determine an exposure for capturing the image using photometric values obtained by the photometry, and
the method comprises the steps of:
obtaining the photometric value as an index value for each of a plurality of subranges of the imaging range of each imaging unit;
determining whether or not a macro imaging mode that provides imaging conditions suitable for capturing the subject at a position close to the stereoscopic imaging device is set for the stereoscopic imaging device; and
if it is determined that the macro imaging mode is not set, comparing the index values of each set of the subranges at mutually corresponding positions in the imaging ranges of the different imaging units with each other, and if a difference between the index values in the imaging ranges of the different imaging units is large enough to satisfy a predetermined criterion, determining that the imaging range of at least one of the imaging units contains an obstacle that is close to the imaging optical system of the at least one of the imaging units.
